(19) United States
(12) Patent Application Publication
(10) Pub. No.: US 2017/0238349 A1
(43) Pub. Date: Aug. 17, 2017

(54) USER APPARATUS AND BASE STATION

(71) Applicant: NTT DOCOMO, INC., Tokyo (JP)

(72) Inventors: Tooru Uchino, Tokyo (JP); Hideaki Takahashi, Tokyo (JP); Wuri Andarmawanti Hapsari, Tokyo (JP)

(73) Assignee: NTT DOCOMO, INC., Tokyo (JP)

(21) Appl. No.: 15/501,891

(22) PCT Filed: Mar. 1, 2016
(86) PCT No.: PCT/JP2016/056238

§ 371 Date: Feb. 6, 2017

(30) Foreign Application Priority Data
May 15, 2015 (JP) 2015-100561

(51) Int. Cl. H04W 76/02; H04W 72/08

(52) U.S. Cl. CPC H04W 76/02; H04W 72/087

(57) ABSTRACT

A user apparatus is provided which communicates with a base station in a mobile communication system which supports LTE. The user apparatus includes a bearer establishing unit configured to establish one or more radio bearers between the user apparatus and the base station; a control unit configured to control activation and deactivation of each of the established radio bearers based on an instruction from the base station; and a communication unit configured to transmit and receive data to and from the base station by using the activated radio bearers.

### BACKGROUND OF THE INVENTION

1. Field of the Invention

The present invention relates to a user apparatus and a base station.

2. Description of the Related Art

In a mobile communications system which uses long term evolution (LTE), by considering a machine type communication (MTC) terminal used for a smart meter, etc., communication specifications for realizing a relatively inexpensive terminal have been discussed (refer to, for example, Non-Patent Literature 1).

For example, in the release 10 of the 3rd Generation Partnership Project (3GPP), simplified implementation of a user apparatus has been provided by mainly defining communication specifications in which the number of data bits is restricted in communications performed between a base station and the user apparatus.

In LTE, a user apparatus performs radio communications by establishing a bearer (communication path for data transmission) between the user apparatus and a base station. The bearer established between a user apparatus and a base station is referred to as a radio bearer (RB). Further, the radio bearer includes a signaling radio bearer (SRB) used for control signal transmission and a data radio bearer (DRB) used for user data transmission.

Further, in a radio link control (RLC) protocol used for radio communications performed between a user apparatus and a base station, any one of transfer modes can be set for each radio bearer. Specifically, there are an RLC-acknowledge mode (RLC-AM) in which retransmission control is performed based on an acknowledgment signal from a receiving side, an RLC-unacknowledge mode (RLC-UM) in which retransmission control is not performed, and a transparent mode (TM) in which RLC is transparently transmitted.

### CITATION LIST

### Non-Patent Literature

### [Non-Patent Literature 1] 3GPP T522.368 V13.1.0 (2014-12)

### [Non-Patent Literature 2] 3GPP T536.331 V12.5.0 (2015-03)

### SUMMARY OF THE INVENTION

### Technical Problem

In conventional LTE, it is a prerequisite of a user apparatus to communicate with a base station by using multiple radio bearers, and processing capability that the user apparatus should have as a minimum is specified in the LTE specifications. Specifically, it is specified that the user apparatus should have processing capability of communications using at least two SRBs at the same time and using four RLC-AM DRBs (e.g., refer to Non-Patent Literature 2) at the same time.

However, it is not expected in the first place for a relatively inexpensive user apparatus such as the above described MTC terminal to perform complex communications using multiple radio bearers. In other words, according to conventional LTE specifications, a user apparatus such as an MTC terminal needs to have wastefully high processing capability, which will be considered as a cause of unnecessary cost increase.

The present invention has been made in view of the above, and it is an object of the present invention to provide a technique capable of reducing radio bearers used for radio communications performed between a user apparatus and a base station.

### Solution to Problem

According to an embodiment, a user apparatus is provided which communicates with a base station in a mobile communication system which supports LTE.

The user apparatus includes a bearer establishing unit configured to establish one or more radio bearers; a control unit configured to control activation and deactivation of each of the established radio bearers based on an instruction from the base station; and a communication unit configured to transmit and receive data to and from the base station by using the activated radio bearers.

### Advantageous Effects of Invention

According to an embodiment of the present invention, a technique is provided which is capable of reducing radio bearers used for radio communications performed between a user apparatus and a base station.

### BRIEF DESCRIPTION OF THE DRAWINGS

FIG. 1 is a drawing illustrating a structure of a mobile communication system according to an embodiment.

FIG. 2A is a drawing illustrating an example of a conventional radio bearer structure.

FIG. 2B is a drawing illustrating an example of a conventional radio bearer structure.

FIG. 3A is a drawing illustrating an example of a structure of radio bearers and logical channels according to a first embodiment.

FIG. 3B is a drawing illustrating an example of a structure of radio bearers and logical channels according to the first embodiment.

FIG. 4 is a drawing illustrating an example of a functional structure of a user apparatus according to the first embodiment.

FIG. 5 is a drawing illustrating an example of a functional configuration of a base station according to the first embodiment.

FIG. 6 is a sequence diagram illustrating an example of processing steps performed by a mobile communication system according to the first embodiment.

FIG. 7A is a drawing illustrating an example of a structure of radio bearers and logical channels according to a second embodiment.

FIG. 7B is a drawing illustrating an example of a structure of radio bearers and logical channels according to the second embodiment.

FIG. 8 is a drawing illustrating an example of a functional structure of a user apparatus according to the second embodiment.

FIG. 9 is a drawing illustrating an example of a functional configuration of a base station according to the second embodiment.

FIG. 10 is a sequence diagram illustrating an example of processing steps (No. 1) performed by a mobile communication system according to the second embodiment.

FIG. 11 is a sequence diagram illustrating an example of processing steps (No. 2) performed by a mobile communication system according to the second embodiment.

FIG. 12 is a sequence diagram illustrating an example of processing steps (No. 3) performed by a mobile communication system according to the second embodiment.

FIG. 13A is a drawing illustrating an example of a structure of radio bearers and logical channels according to a third embodiment.

FIG. 13B is a drawing illustrating an example of a structure of radio bearers and logical channels according to the third embodiment.

FIG. 14 is a drawing illustrating an example of a functional structure of a user apparatus according to the third embodiment.

FIG. 15 is a drawing illustrating an example of a functional configuration of a base station according to the third embodiment.

FIG. 16 is a sequence diagram illustrating an example of processing steps performed by a mobile communication system according to the third embodiment.

FIG. 17 is a drawing illustrating an example of a hardware configuration of a user apparatus according to an embodiment.

FIG. 18 is a drawing illustrating an example of a hardware configuration of a central base station according to an embodiment.

### DETAILED DESCRIPTION OF THE PREFERRED EMBODIMENTS

In the following, referring to the drawings, embodiments of the present invention will be described. It should be noted that the embodiments described below are merely examples and the embodiments to which the present invention is applied are not limited to the following embodiments. For example, it is assumed that a mobile communication system according to an embodiment complies with LTE standard. However, the present invention can be applied, not limited to LTE, but can be applied also to other schemes. It should be noted that, in the application specification and claims, the term “LTE” is used, not only to mean a communication method corresponding to 3GPP release 8 or 9, but also to mean a communication method corresponding to 3GPP release 10, 11, 12, 13, or later.

Further, two or more of the first embodiment, the second embodiment, and the third embodiment, which will be described below, may be combined arbitrarily.

<Overview>

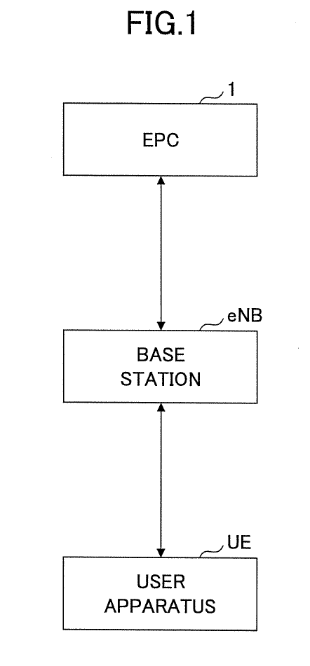

FIG. 1 is a drawing illustrating a structure example of a mobile communication system according to an embodiment. As illustrated in FIG. 1, a mobile communication system according to an embodiment includes a user apparatus UE, a base station eNB, and an evolved packet core (EPC) 1. For the sake of illustration convenience, a single user apparatus UE is shown in FIG. 1. Multiple user apparatuses UEs may be included.

The user apparatus UE has a function for communicating with the base station eNB, the EPC 1, etc., via radio. The user apparatus UE may be, for example, a mobile phone, a smartphone, a tablet, a mobile router, a wearable terminal, an MTC terminal, etc. The user apparatus UE may be any apparatus as long as it has a communication function. The user apparatus UE includes hardware resources such as a CPU including a processor, a memory apparatus including a ROM, a RAM, a flash memory, etc., an antenna used for communications with the base station eNB, a radio frequency (RF) apparatus, etc.

Functions and processes of the user apparatus UE may be realized by having the processor processing data or executing programs stored in the memory apparatus. However, the hardware configuration of the user apparatus UE is not limited to the above, and the user apparatus UE may have any other appropriate hardware configuration.

The base station eNB performs communications with the user apparatus UE and the EPC 1. The base station eNB includes hardware resources such as a CPU including a processor, a memory apparatus including a ROM, a RAM, a flash memory, etc., an antenna used for communications with the user apparatus UE, etc., a communication interface apparatus for communicating with an adjacent base station, etc. Functions and processes of the base station eNB may be realized by having the processor processing data or executing programs stored in the memory apparatus. However, the hardware configuration of the base station eNB is not limited to the above, and the base station eNB may have any other appropriate hardware configuration.

The EPC 1 is a core network of LTE, and includes multiple apparatuses such as mobility management entity (MME) which provides a mobility control function, an EPS bearer control function, etc., a packet data network gateway (PGW) which is a gate way apparatus for connecting the EPC1 to an external network (packet data network (PDN)), and a serving gateway (SGW) for relaying a U-plane signal between the base station eNB and the PGW.

Here, in the case where the user apparatus UE communicates with a predetermined PDN for receiving a predetermined service (e.g., Internet access), multiple bearers are established between the user apparatus UE and a radio network and a core network. First, there is an EPS bearer which will be established between the user apparatus UE and the PGW. The EPS bearer is associated with a quality of service (QoS) parameter, and is used for transmitting user data with predetermined QoS between the user apparatus UE and the PDN via the PGW.

The EPS bearer is further divided into an E-UTRAN radio access bearer (E-RAB) which is established between a user apparatus UE and the SGW, and a S5/S8 bearer which is established between the SGW and the PGW. The E-RAB is further divided into a radio bearer established between the user apparatus UE and the base station eNB, and a S1 bearer which is established between the base station eNB and the SGW. Further, the radio bearer includes an SRB used for control signal transmission and a DRB used for user data transmission. The SRB is specifically used for transmission of a radio resource control (RRC) signal and a non access stratum (NAS) signal. The NAS signal is a control signal transmitted and received for establishing, for example, an EPS bearer between the user apparatus UE and the MME. According to LTE specifications, multiple SRBs (SRB0, SRB1, SRB2) are specified depending on the RRC signal usage, and an ID used for uniquely identifying the SRB is referred to as a SRB identity. Further, the DRB is associated one to one with the QoS parameter. In other words, in the case where multiple DRBs are established between the user apparatus UE and the base station eNB, one QoS parameter associated with a DRB is different from another QoS parameter associated with another DRB. An ID used for uniquely identifying a DRB is referred to as a DRB identity.

It should be noted that, in LTE, a radio bearer is associated one to one with a logical channel (LCH). In the following description, it can be considered that the radio bearer is the same as the logical channel.

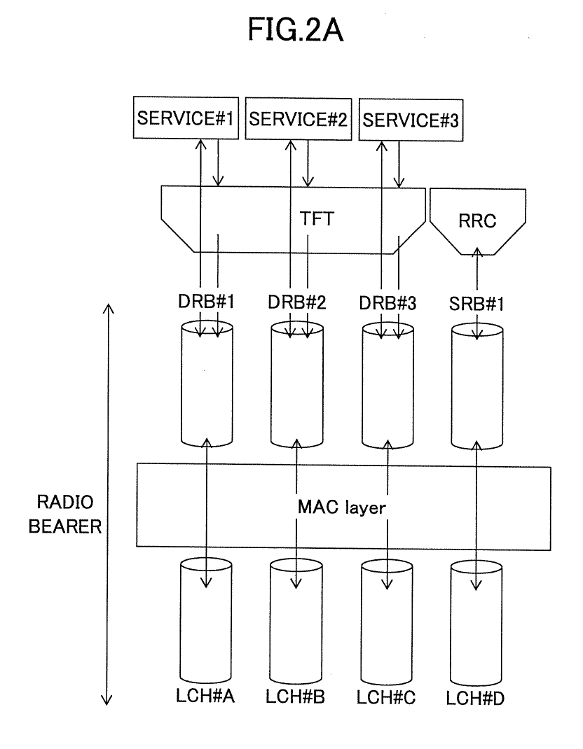

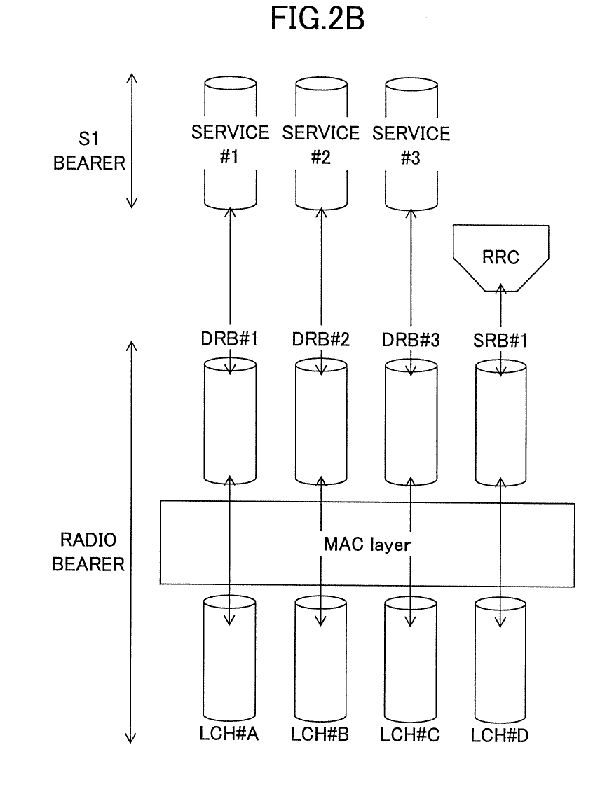

FIG. 2A and FIG. 2B are drawings illustrating examples of a conventional radio bearer structure. FIG. 2A illustrates an example of a radio bearer structure established by the user apparatus UE, and FIG. 2B illustrates an example of a radio bearer structure established by the base station eNB. In FIGS. 2A and 2B, it is assumed that each of service#1 through service#3 requires different QoS such as QoS for an Internet access service based on best efforts and QoS for a high quality voice over IP (VoIP) communication service.

As illustrated in FIG. 2A, the user apparatus UE transmits and receives data sets for the multiple services (service#1 through service#3) by mapping the data sets to DRB#1 through DRB#3, and by mapping the DRB#1 through DRB#3 to logical channels (LCH#A through LCH#C) by using a MAC layer function, respectively. Further, the user apparatus UE transmits and receives an RRC signal (including an encapsulated (piggy-backed) NAS signal) by mapping the RRC signal to SRB#1 and by mapping the SRB#1 to a logical channel (LCH#D) by using the MAC layer function. It should be noted that the logical channels (LCH#A, LCH#B, LCH#C) are, for example, a dedicated control channel (DCCH), and the logical channel (LCH#D) is, for example, a DCCH or a common control channel (CCCH). It should be noted that the downlink data sets of the data transmitted and received for the services (service#1 through service#3) are mapped to the DRB#1 through DRB #3 by using a traffic flow template (TFT) function. It should be noted that the TFT function is a filtering function for dividing an IP packet into appropriate bearers.

Further, as illustrated in FIG. 2B, the base station eNB transmits and receives data sets transmitted and received via S1 bearers to and from the SGW by mapping the data sets to DRB#1 through DRB#3, and by mapping the DRB#1 through DRB#3 to logical channels (LCH#A through LCH#C) by using a MAC layer function, respectively. Further, the base station eNB transmits and receives an RRC signal (including an encapsulated (piggy-backed) NAS signal) by mapping the RRC signal to the SRB#1 and by mapping the SRB#1 to a logical channel (LCH#D) by using the MAC layer function.

In a mobile communication system according to an embodiment, the number of radio bearers and logical channels used simultaneously for communications between the user apparatus UE and the base station eNB is reduced by controlling in many ways the radio bearers (SRB and DRB) established between the user apparatus UE and the base station eNB. In the following, a first embodiment, a second embodiment, and a third embodiment will be described.

It should be noted that, in the following description, it is assumed that the RRC signal includes the NAS signal encapsulated (piggy-backed) by the RRC signal.

### First Embodiment

In a mobile communication system according to a first embodiment, it is possible to establish multiple radio bearers and logical channels between the user apparatus UE and the base station eNB, and then to activate and deactivate the established radio bearers and logical channels. To activate a radio bearer and a logical channel is to bring the radio bearer and logical channel to a state capable of transmitting and receiving data, and to deactivate a radio bearer and a logical channel is to bring the radio bearer and logical channel to a state incapable of transmitting and receiving data The base station eNB activates radio bearers and logical channels, of the radio bearers and logical channels which have been established, in a range of processing capability of the user apparatus UE.

As described above, in conventional LTE, it is necessary to have processing capability to communicate by using at least two SRBs at the same time and using four RLC-AM DRBs at the same time. According to the first embodiment, it is possible for the base station eNB to reduce the number of simultaneously communicating radio bearers and logical channels in a range of processing capability of the user apparatus UE.

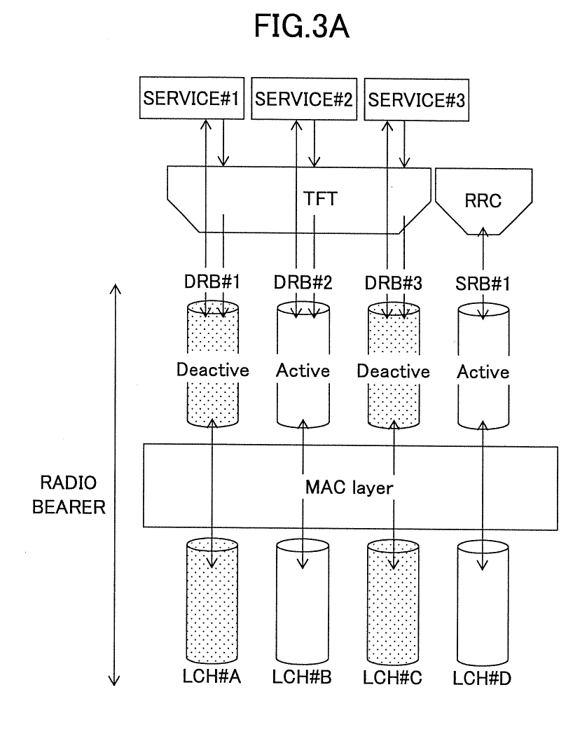

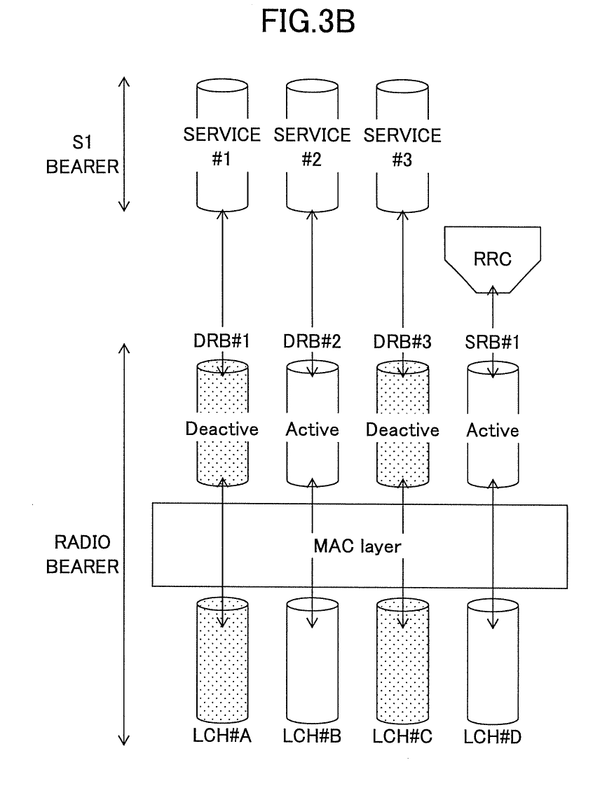

FIG. 3A and FIG. 3B are drawings illustrating examples of a structure of radio bearers and logical channels according to the first embodiment. FIG. 3A illustrates an example of a structure of radio bearers and logical channels established by a user apparatus UE, and FIG. 3B illustrates an example of a structure of radio bearers and logical channels established by a base station eNB. It should be noted that the structures illustrated in FIG. 3A and FIG. 3B are merely examples. The number of established radio bearers and logical channels may be one or plural. In FIG. 3A and FIG. 3B, only one SRB (SRB#1) is shown for the sake of illustration convenience. Multiple SRBs may be established. Further, points not specifically described may be the same as FIG. 2A or FIG. 2B. According to the first embodiment, the radio bearers and the logical channels can be activated and deactivated at any timing. It is the base station eNB that activates and deactivates the radio bearers and the logical channels.

FIG. 3A illustrates a state in which DRB#1, LCH#A, DRB#3 and LCH#C are deactivated, and DRB#2, LCH#B, SRB#1, and LCH#D are activated. In this state, it is possible for the user apparatus UE to transmit simultaneously the user data related to the service#2 and the RRC signal to the base station eNB.

Similar to FIG. 3A, FIG. 3B illustrates a state in which DRB#1, LCH#A, DRB#3, and LCH#C are deactivated, and DRB#2, LCH#B, SRB#1, and LCH#D are activated. In this state, it is possible for the base station eNB to transmit simultaneously the user data related to the service#2 and the RRC signal to the user apparatus UE. It should be noted that, in FIG. 3B, in the case where data is received from S1 bearers corresponding to deactivated radio bearers and logical channels (in FIG. 3B, S1 bearers related to service#1 and service#3), the base station eNB may store the received data in a buffer for a moment. Further, the base station eNB may deactivate, similar to the radio bearers and logical channels, the S1 bearers in cooperation with a SGW.

<Functional Structure>

(User Apparatus)

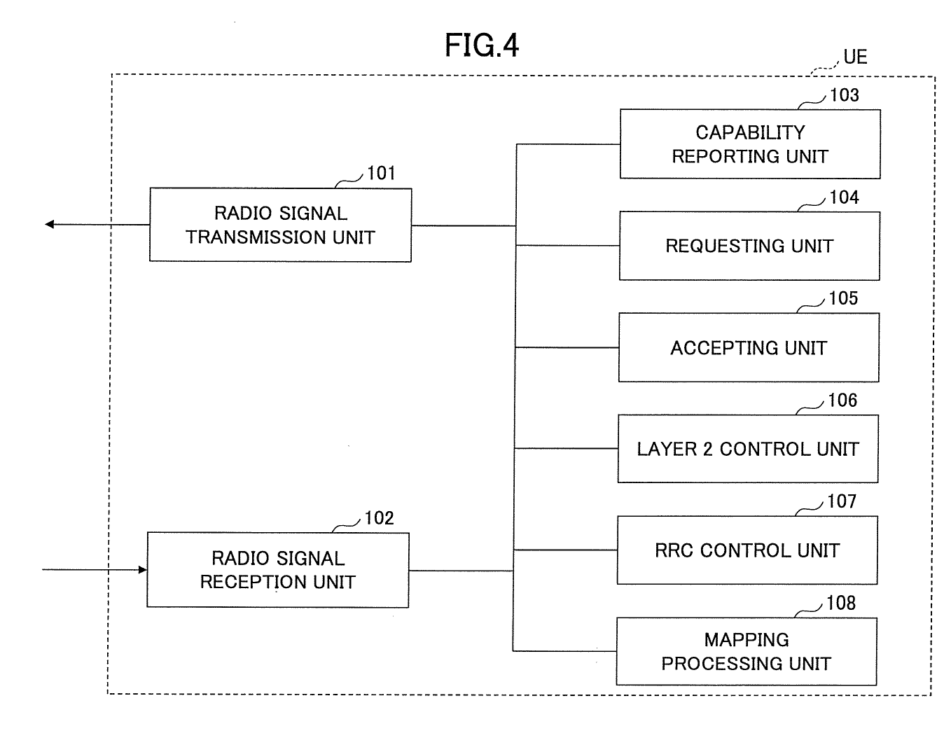

FIG. 4 is a drawing illustrating an example of a functional structure of a user apparatus UE according to the first embodiment. As illustrated in FIG. 4, the user apparatus UE includes a radio signal transmission unit 101, a radio signal reception unit 102, a capability reporting unit 103, a requesting unit 104, an accepting unit 105, a layer 2 control unit 106, an RRC control unit 107, and a mapping processing unit 108. FIG. 4 illustrates functional units of the user apparatus UE especially related to an embodiment only, and thus, the user apparatus UE further includes at least functions for performing operations according to LTE (not shown in the figure). Further, a functional structure illustrated in FIG. 4 is merely an example. Functional classification and names of functional units may be anything as long as operations related to an embodiment can be performed. The radio signal transmission unit 101 and the radio signal reception unit 102 include a packet buffer, respectively, and perform processing of physical layer (layer 1).

The capability reporting unit 103 transmits to the base station eNB capability information indicating the number of radio bearers and logical channels the user apparatus can activate at the same time. In the capability information, a specific number of radio bearers and logical channels, for example, may be included. Further, the capability information may include individual numbers of DRBs and SRBs the user apparatus UE can activate at the same time. Further, for example, a specific UE category indicating an MTC terminal may be defined in advance between the base station eNB and the user apparatus UE, and the specific UE category may be included in the capability information. In this case, the base station eNB determines the number of radio bearers and logical channels the user apparatus UE can activate at the same time based on the specific UE category.

The requesting unit 104 has a function for requesting the base station eNB to activate the radio bearers and the logical channels in the case of transmitting user data or an RRC signal related to a predetermined service (corresponding to a predetermined QoS) and in the case where the radio bearers and the logical channels associated with the user data or the RRC signal have not been activated. The accepting unit 105 accepts an instruction from the base station eNB to activate and deactivate radio bearers and logical channels, and instructs the layer 2 control unit 106 to activate and deactivate the designated radio bearers and logical channels.

The layer 2 control unit 106 performs processing of layer 2 (media access control (MAC) layer, RLC layer, packet data convergence protocol (PDCP) layer) with the base station eNB. Further, the layer 2 control unit 106 activates and deactivates radio bearers and logical channels according to the instruction of the accepting unit 105. Further, the layer control 106 stores states of radio bearers and logical channels indicating whether radio bearers and logical channels are activated or deactivated.

The RRC control unit 107 performs RRC signal transmission and reception to and from the base station eNB, and performs various types of RRC layer related processes.

The mapping processing unit 108 has a function for mapping data which is transmitted and received in each service to a radio bearer corresponding to required QoS based on the QoS required for the service performed by the user apparatus UE. Further, the mapping processing unit 108 has a function for mapping an RRC signal to a radio bearer used for the RRC signal transmission and reception. It should be noted that the mapping processing unit 108 may include the TFT function illustrated in FIG. 3.

(Base Station)

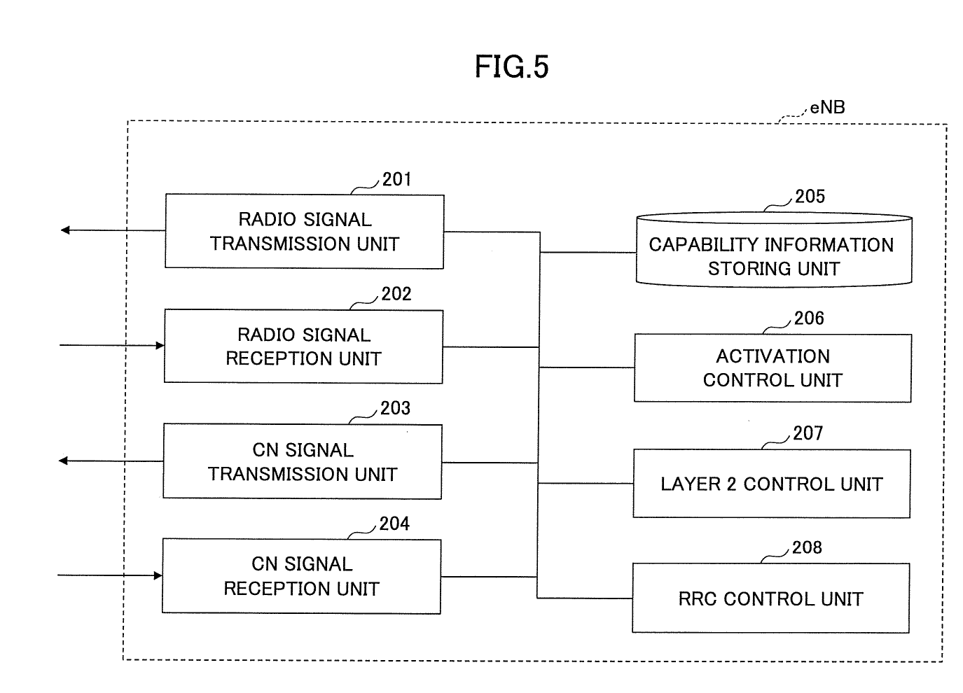

FIG. 5 is a drawing illustrating an example of a functional structure of a base station eNB according to the first embodiment. As illustrated in FIG. 5, the base station eNB includes a radio signal transmission unit 201, a radio signal reception unit 202, a core network (CN) signal transmission unit 203, a CN signal reception unit 204, a capability information storing unit 205, an activation control unit 206, a layer 2 control unit 207, and an RRC control unit 208. FIG. 5 illustrates functional units of the base station eNB especially related to an embodiment only, and thus, the base station eNB further includes at least functions for performing operations according to LTE (not shown in the figure). Further, a functional structure illustrated in FIG. 5 is merely an example. Functional classification and names of functional units may be anything as long as operations related to an embodiment can be performed.

The radio signal transmission unit 201 and the radio signal reception unit 202 include a packet buffer and perform processing of physical layer (layer 1), respectively.

The CN signal transmission unit 203 and the CN signal reception unit 204 have a function for communicating with the MME and the S-GW included in the EPC 1. Further, the CN signal transmission unit 203 and the CN signal reception unit 204 have a function for terminating the S1 bearer. The CN signal transmission unit 203 and the CN signal reception unit 204 controls association between the S1 bearers and the radio bearers in cooperation with the layer 2 control unit 207.

The capability information storing unit 205 is realized by a memory included in the base station eNB, and stores capability information received from the user apparatus UE.

The activation control unit 206 instructs the user apparatus to activate and deactivate radio bearers and logical channels in such a way that the number of activated radio bearers and logical channels do not exceed the processing capability of the user apparatus UE (the number of radio bearers and logical channels the user apparatus can activate at the same time). Further, the activation control unit 206 reports to the layer 2 control unit the radio bearers and the logical channels to be activated and deactivated.

The layer 2 control unit 207 performs processing of a layer 2 (media access control (MAC) layer, an RLC layer, a packet data convergence protocol (PDCP) layer) with the user apparatus UE. Further, the layer 2 control unit 207 activates and deactivates radio bearers and logical channels according to an instruction of the activation control unit 206. Further, the layer 2 control unit 207 stores states of radio bearers and logical channels of each of user apparatuses UEs under control of the base station eNB indicating whether radio bearers and logical channels are activated or deactivated.

The RRC control unit 208 performs RRC signal transmission and reception with the user apparatus UE, and performs various types of RRC layer related processes.

<Processing Steps>

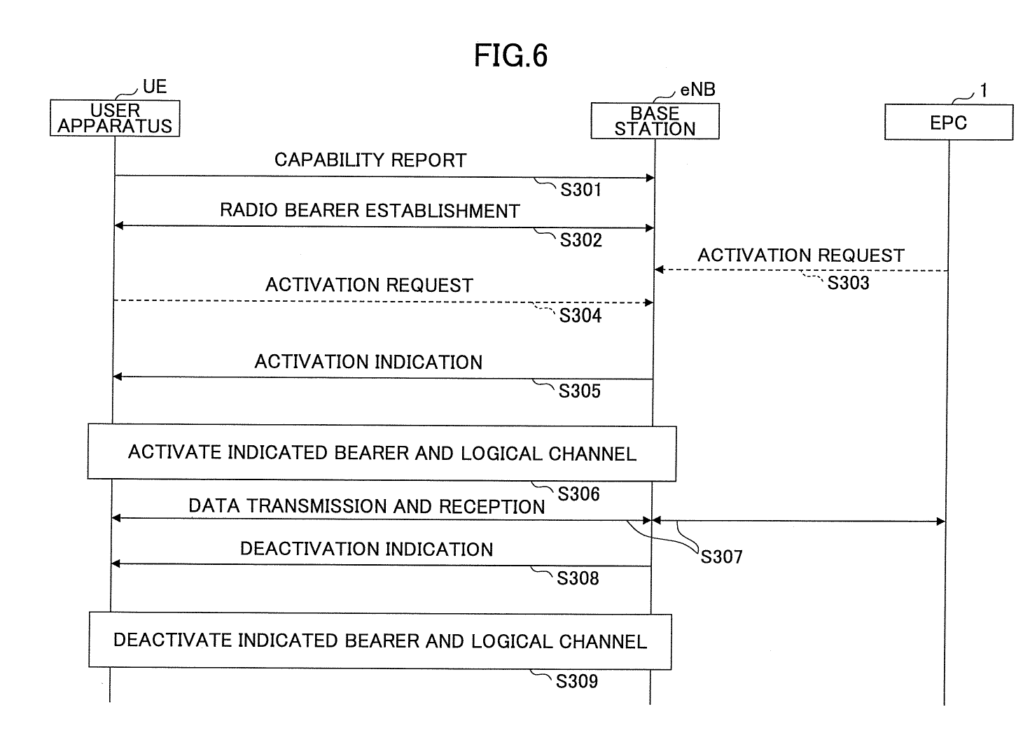

FIG. 6 is a sequence diagram illustrating an example of processing steps performed by a mobile communication system according to the first embodiment. Referring to FIG. 6, the processing steps will be specifically described in which one or more radio bearers and logical channels established between the user apparatus UE and the base station eNB are activated or deactivated.

It should be noted that, in FIG. 6, processing steps of step S303 through step S306 are performed for activating radio bearers and logical channels, and processing steps of step S308 through step S309 are performed for deactivating radio bearers and logical channels. In other words, the processing steps of step S303 through step S306 and the processing steps of step S307 through step S309 are not necessarily performed sequentially in this order, but are performed asynchronously according to the activation or deactivation of radio bearers and logical channels.

In step S301, the capability reporting unit 103 of the user apparatus UE transmits a capability reporting signal to the base station eNB. The capability reporting signal includes quality information. The capability reporting signal may be, for example, an RRC signal (e.g., UE capability information), a MAC signal, or a physical layer signal.

In step S302, one or more radio bearers and logical channels are established for each QoS corresponding to user data transmitted and received between the layer 2 control unit 106 of the user apparatus UE and the layer 2 control 207 of the base station eNB. Further, one or more radio bearers and logical channels are established for RRC signal transmission. It should be noted that the one or more radio bearers and logical channels may be establish initially in a deactivated state.

In step S303, the CN signal reception unit 204 of the base station eNB receives an activation request signal from the EPC1. The activation request signal may be a control signal transmitted from the MME (e.g., S1-AP message) or a control signal transmitted from the SGW. Further, the activation request signal may include a QoS parameter indicating QoS corresponding to the user data the EPC1 is going to transmit to the user apparatus UE (e.g., QCI or EPS bearer ID), or information indicating that the MME is going to transmit a NAS signal to the user apparatus UE (hereinafter, referred to as “NAS transmission indication information).

Further, the CN signal reception unit 204 of the base station eNB may not receive the activation request signal from the EPC1, but, by receiving the user data to be transmitted to the user apparatus UE via a S1 bearer, may determine that the activation of radio bearers and logical channels corresponding to the S1 bearer is requested. Further, the CN signal reception unit 204 of the base station eNB may, by receiving a message including a NAS signal from the MME, determine that the activation of radio bearers and logical channels for transmitting and receiving an RRC signal in which the NAS signal is encapsulated is requested.

It should be noted that the processing steps of step S303 may be performed only in the case where there is data the EPC1 is going to transmit to the user apparatus UE.

In step S304, the requesting unit 104 of the user apparatus UE transmits an activation request signal to the base station eNB. The activation request signal may be an RRC signal, a packet data convergence protocol (PDCP) signal, an RLC signal, a MAC control element (CE), or a physical layer signal. The activation request signal may include a QoS parameter corresponding to the user data the user apparatus UE is going to transmit (e.g., QCI or EPS bearer ID), or information indicating that the user apparatus UE is going to transmit an RRC signal to the base station eNB. Further, the activation request signal may include a radio bearer identity (SRB identity, DRB identity) or a logical channel identity (LCH identity) in order to specify a radio bearer and a logical channel which are requested to be activated.

It should be noted that the processing steps of step S304 may be performed only in the case where there is data the user apparatus UE is going to transmit to the base station eNB and the radio bearer and the logical channel corresponding to the data to be transmitted are in a deactivated state.

In step S305, the activation control unit 206 of the base station eNB transmits an activation indication signal to the user apparatus UE. The activation indication signal includes, for example, a radio bearer identity (SRB identity, DRB identity) or a logical channel identity (LCH identity). Further, the activation control unit 206 reports to the layer 2 control unit 207 radio bearers and logical channels as activation targets. The activation indication signal may be an RRC signal, a PDCP signal, an RLC signal, a MAC CE, or a physical layer signal.

In step S306, the layer 2 control unit 106 of the user apparatus UE and the layer 2 control unit 207 of the base station eNB activate the radio bearers and the logical channels specified in the processing steps of step S305.

In step S307, by using the activated radio bearers and the logical channels, transmission and reception of the user data or the RRC signal are performed.

In step S308, the activation control unit 206 of the base station eNB transmits a deactivation indication signal to the user apparatus UE. The deactivation indication signal includes, for example, a radio bearer identity (SRB identity, DRB identity) or a logical channel identity (LCH identity). Further, the activation control unit 206 reports to the layer 2 control unit 207 radio bearers and logical channels as deactivation targets. The deactivation indication signal may be an RRC signal, a PDCP signal, an RLC signal, a MAC CE, or a physical layer signal.

In step S309, the layer 2 control unit 106 of the user apparatus UE and the layer 2 control unit 207 of the base station eNB deactivate the radio bearers and the logical channels specified in the processing steps of step S305. It should be noted that, when deactivating the radio bearers and the logical channels, the layer 2 control unit 106 of the user apparatus UE and the layer 2 control unit 207 of the base station eNB may perform RLC re-establish processing or PDCP re-establish processing in order to remove data stored in the RLC layer and the PDCP layer. Further, similarly, the layer 2 control unit 106 of the user apparatus UE and the layer 2 control unit 207 of the base station eNB may remove data stored in a HARQ buffer in the MAC layer.

It should be noted that when transmitting the activation indication signal to the user apparatus UE in processing steps of step S305, the activation control unit 206 of the base station eNB asks the layer 2 control unit 207 for the number of radio bearers and logical channels which have already been activated, obtains capability information of the user apparatus UE from the capability information storing unit 205, makes sure that the number of radio bearers and logical channels the user apparatus UE can activate at the same time is not exceeded, and transmits the activation indication signal to the user apparatus UE. Further, in the case where the number of radio bearers and logical channels which have already been activated is equal to the number of radio bearers and logical channels the user apparatus UE can activate at the same time, the activation control unit 206 deactivates any of radio bearers and logical channels which have already been activated by using processing steps of step S308 and step S309, and then, transmits the activation indication signal to the user apparatus UE.

It should be noted that, in processing steps in FIG. 6, in the case where the number of radio bearers and logical channels established in step S302 is equal to or less than the number of radio bearers the user apparatus UE can activate at the same time, the layer 2 control unit 106 of the user apparatus UE and the layer 2 control unit 207 of the base station eNB may establish the one or more radio bearers which are already in an activated state.

Further, the layer 2 control unit 106 of the user apparatus UE and the layer 2 control unit 207 of the base station eNB may establish the SRB and the logical channel corresponding to the SRB, of one or more radio bearers and logical channels established in step S302, in an activated state in advance.

Further, in the case where a part of the one or more radio bearers and the logical channels established in step S302 are removed, and the removed radio bearers and the logical channels have been in an activated state, the layer 2 control unit 106 of the user apparatus UE and the layer 2 control unit 207 of the base station eNB may autonomously activate the radio bearer and the logical channel, of radio bearers and logical channels which are in a deactivated state, whose value of radio bearer identity (SRB identity, DRB identity) or logical channel identity (LCH identity) is the greatest/least.

### Second Embodiment

Next, a second embodiment will be described by referring to the drawings. It should be noted that the description of the same parts as the first embodiment will be omitted. Further, what is not specifically described may be the same as the first embodiment.

In a mobile communication system according to a second embodiment, the number of radio bearers and logical channels established at the same time between the user apparatus UE and the base station eNB is limited to a range of processing capability of the user apparatus UE, and usages of the limited number of radio bearers and logical channels are switched along in time axis, and thus, transmission and reception of user data and an RRC signal corresponding to each QoS are realized by using the limited number of radio bearers and logical channels. It should be noted that the “usage of a radio bearer and logical channel” means a state of the radio bearer and the logical channel indicating for which QoS parameter the radio bearer and the logical channel are used for transmission and reception of the corresponding user data or the RRC signal.

As described above, in conventional LTE, it is necessary to have processing capability of using at least two SRBs and four RLC-AM DRBs simultaneously for communication. According to the second embodiment, it is possible for the base station eNB to reduce the number of radio bearers and logical channels used simultaneously for communication in a range of processing capability of the user apparatus UE.

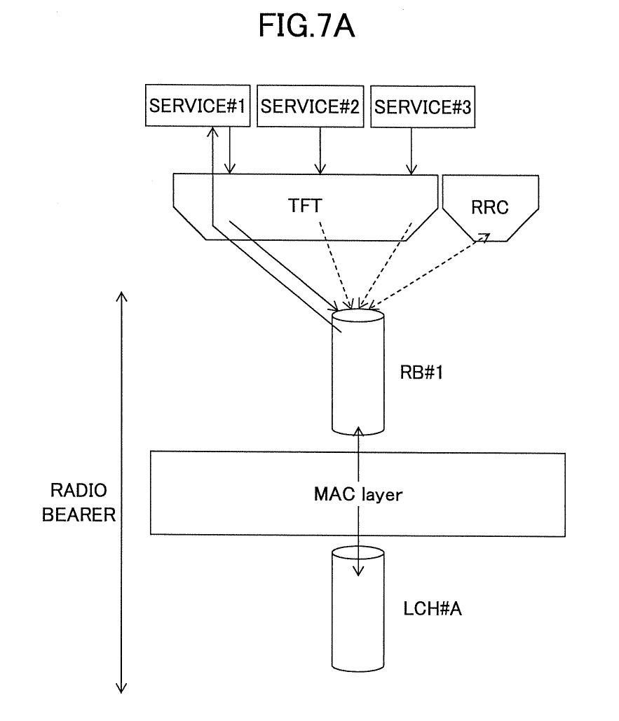

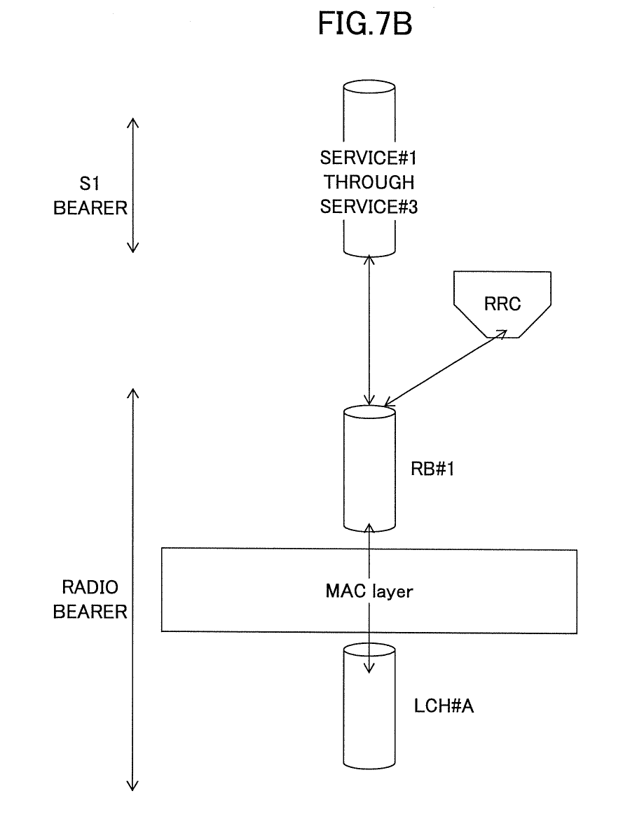

FIG. 7A and FIG. 7B are drawings illustrating examples of a structure of radio bearers and logical channels according to the second embodiment. FIG. 7A illustrates an example of a structure of a radio bearer and a logical channel established by a user apparatus UE, and FIG. 7B illustrates an example of a structure of a radio bearer and a logical channel established by a base station eNB. It should be noted that the structures illustrated in FIG. 7A and FIG. 7B are merely examples. In FIG. 7A and FIG. 7B, for the sake of illustration convenience, only a single radio bearer and a single logical channel (RB#1 and LCH#A) are illustrated. However, multiple radio bearers and logical channels may be established within a range of processing capability of the user apparatus UE. Further, points not specifically described may be the same as FIG. 2A or FIG. 2B.

FIG. 7A illustrates a state in which transmission and reception of user data related to the service#1, of user data sets related to the service#1 through service #3 and an RRC signal, are performed by using the RB#1 and the LCH#A. Similar to FIG. 7A, FIG. 7B illustrates a state in which transmission and reception of the user data set related to the service#1, of user data sets related to the service#1 through service #3 and an RRC signal, are performed by using the RB#1 and the LCH#A. In other words, FIG. 7A and FIG. 7B illustrate a state in which the usage of the RB#1 and the LCH#A is switched to transmitting and receiving user data related to the service#1.

It should be noted that, in an example of FIG. 7B, it is assumed, but not limited to, that the same number of S1 bearers, as the number of radio bearers and logical channels established at the same time between the user apparatus UE and the base station eNB, are established between the base station eNB and the SGW.

In the second embodiment, the usage of radio bearers and logical channels can be switched at any timing. For example, in FIG. 7A and FIG. 7B, it is possible to switch the usage of the RB#1 and the LCH#A to for transmitting and receiving user data related to the service#2. Further, it is possible to switch the usage of the RB#1 and the LCH#A to for transmitting and receiving user data related to the service#3. Further, it is possible to switch the usage of the RB#1 and the LCH#A to for transmitting and receiving an RRC signal.

In the second embodiment, as a method (No. 1) of switching the usage of the radio bearers and logical channels, for example, the usage may be switched by an instruction from the base station eNB. Further, as a method (No. 2) of switching the usage of the radio bearers and logical channels, the usage may be switched automatically at a predetermined periodical timing. Further, as a method (No. 3) of switching the usage of the radio bearers and logical channels, during a certain period of time from when user data corresponding to a predetermined QoS or an RRC signal is transmitted from the base station eNB to the user apparatus UE, the usage of the radio bearers and logical channels is automatically switched to for transmitting and receiving the user data corresponding to the predetermined QoS or the RRC signal.

<Functional Structure>

(User Apparatus)

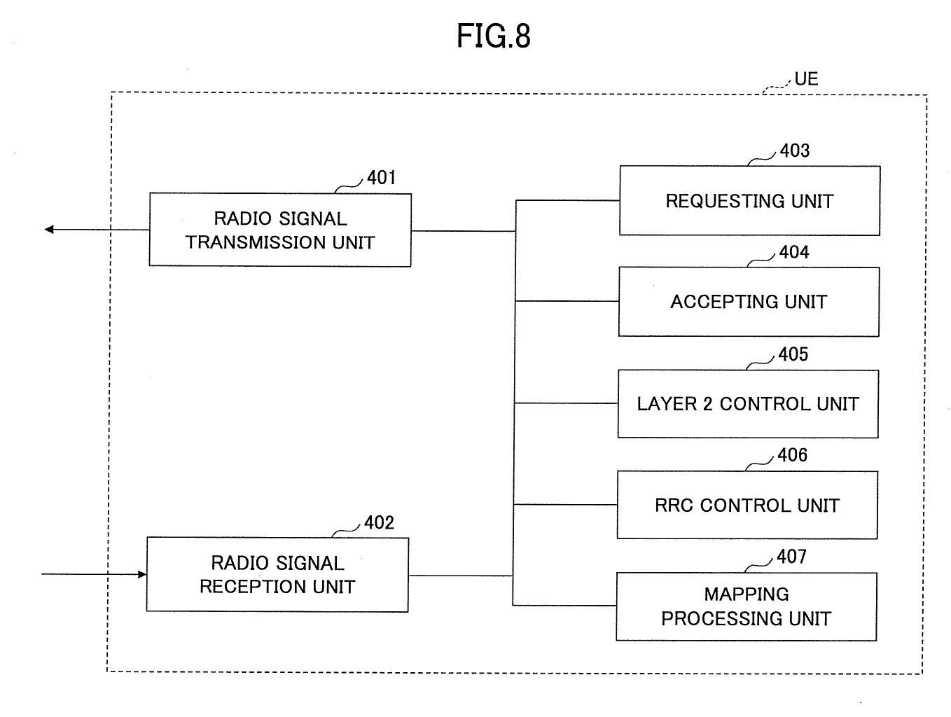

FIG. 8 is a drawing illustrating an example of a functional structure of a user apparatus UE according to the second embodiment. As illustrated in FIG. 8, the user apparatus UE includes a radio signal transmission unit 401, a radio signal reception unit 402, a requesting unit 403, an accepting unit 404, a layer 2 control unit 405, an RRC control unit 406, and a mapping processing unit 407. FIG. 8 illustrates functional units of the user apparatus UE especially related to an embodiment only, and thus, the user apparatus UE further includes at least functions for performing operations according to LTE (not shown in the figure). Further, a functional structure illustrated in FIG. 8 is merely an example. Functional classification and names of functional units may be anything as long as operations related to an embodiment can be performed.

The radio signal transmission unit 401 and the radio signal reception unit 402 include a packet buffer and perform processing of physical layer (layer 1), respectively,

The requesting unit 403 requests the base station eNB to switch the usage of the radio bearers and logical channels in the case of transmitting user data related to a predetermined service (corresponding to a predetermined QoS) or an RRC signal and in the case where the usage of the radio bearers and logical channels is not for transmitting and receiving the user data related to the predetermined service (corresponding to a predetermined QoS or the RRC signal).

The accepting unit 404 accepts an instruction from the base station eNB indicating to switch the usage of the radio bearers and logical channels, and instructs the layer 2 control unit to switch the usage of the radio bearers and logical channels to the instructed usage of the radio bearers and logical channels.

The layer 2 control unit 405 performs processing of layer 2 (media access control (MAC) layer, RLC layer, packet data convergence protocol (PDCP) layer) with the base station eNB. Further, the layer 2 control unit 405 switch the usage of the radio bearers and logical channels according to the instruction of the accepting unit 404. Further, the layer 2 control unit 405 stores states of the radio bearers and logical channels which states indicate which usage the radio bearers and logical channels are used for.

The RRC control unit 406 performs RRC signal transmission and reception to and from the base station eNB, and performs various types of RRC layer related processes.

The mapping processing unit 407 has a function for mapping data transmitted and received in a service performed by the user apparatus UE to radio bearers in the case where the usage of the radio bearers is for transmitting and receiving the user data corresponding to QoS required for the service performed by the user apparatus UE. Further, the mapping processing unit 407 has a function for mapping an RRC signal to a radio bearer in the case where the usage of the radio bearer is for transmitting and receiving the RRC signal. It should be noted that the mapping processing unit 407 may include the TFT function illustrated in FIG. 7.

(Base Station)

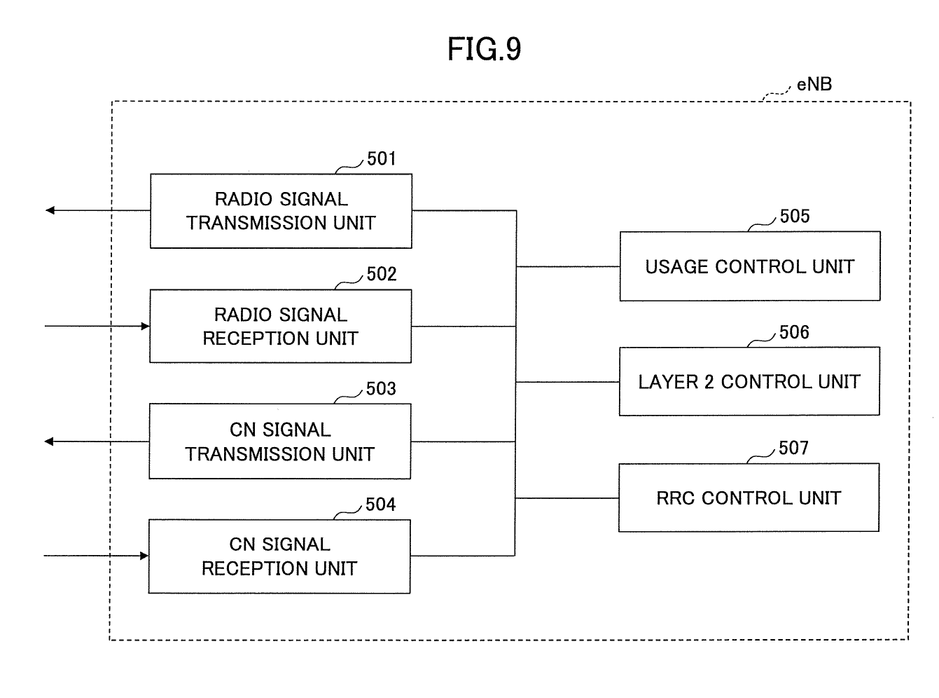

FIG. 9 is a drawing illustrating an example of a functional structure of a base station eNB according to the second embodiment. As illustrated in FIG. 9, the base station eNB includes a radio signal transmission unit 501, a radio signal reception unit 502, a CN signal transmission unit 503, a CN signal reception unit 504, a usage control unit 505, a layer 2 control unit 506, and an RRC control unit 507. FIG. 9 illustrates functional units of the base station eNB especially related to an embodiment only, and thus, the base station eNB further includes at least functions for performing operations according to LTE (not shown in the figure). Further, a functional structure illustrated in FIG. 9 is merely an example. Functional classification and names of functional units may be anything as long as operations related to an embodiment can be performed. The radio signal transmission unit 501, the radio signal reception unit 502, the CN signal transmission unit 503, and the CN signal reception unit 504 are the same as the radio signal transmission unit 201, the radio signal reception unit 202, the CN signal transmission unit 203, and the CN signal reception unit 204 according to the first embodiment, and thus, the descriptions are omitted.

The usage control unit 505 instructs the user apparatus UE to switch the usage of the radio bearers and logical channels based on a request from the user apparatus UE or the EPC 1. Further, the usage control unit 505 reports to the layer 2 control unit 506 the usage of the radio bearers and logical channels instructed to the user apparatus UE.

The layer 2 control unit 506 performs processing of layer 2 (media access control (MAC) layer, RLC layer, packet data convergence protocol (PDCP) layer) with the user apparatus UE. Further, the layer 2 control unit 506 switches the usage of the radio bearers and logical channels according to the instruction of the usage control unit 505. The layer 2 control 207 stores states of radio bearers and logical channels for each of user apparatuses UE under control of the base station eNB, which states indicate which usage the radio bearers and logical channels are used for.

The RRC control unit 507 performs RRC signal transmission and reception to and from the user apparatus UE, and performs various types of RRC layer related processes.

<Processing Steps>

(Switching Method (No. 1))

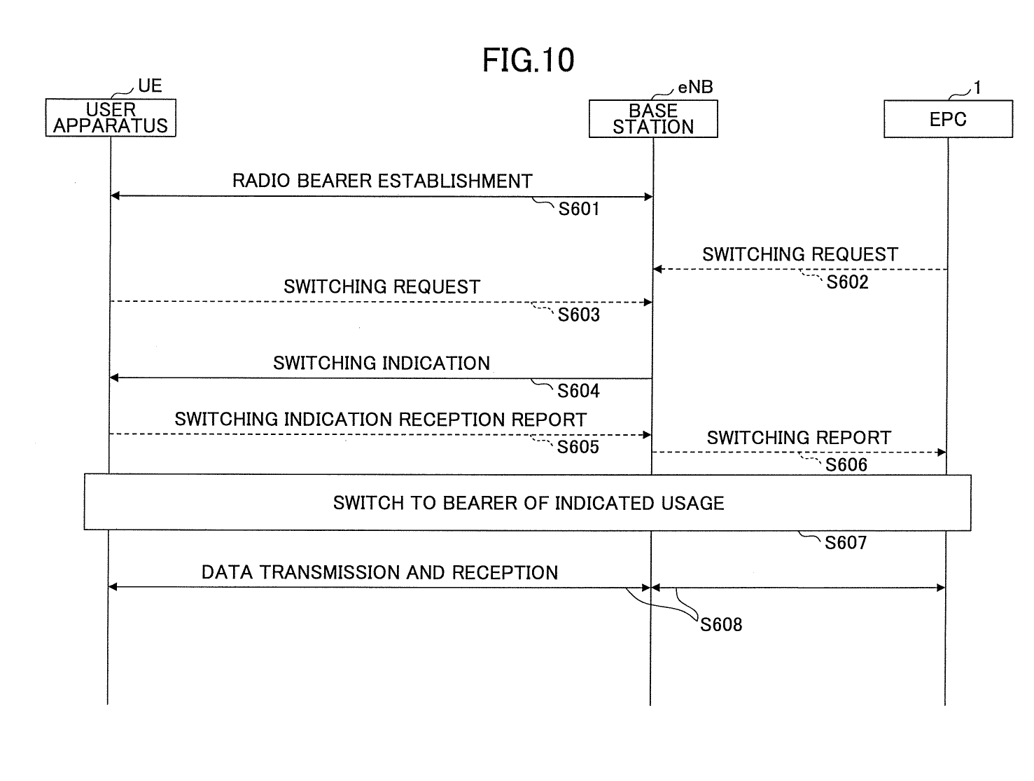

FIG. 10 is a sequence diagram illustrating an example of processing steps (No. 1) performed by a mobile communication system according to the second embodiment. Referring to FIG. 10, the processing steps (No. 1) will be specifically described in which the usage of the radio bearers and logical channels established between the user apparatus UE and the base station eNB is switched.

In step S601, one or more radio bearers and logical channels are established between the layer 2 control unit 405 of the user apparatus UE and the layer 2 control unit 506 of the base station eNB. It should be noted that, in processing steps of step S601, when the radio bearers and logical channels are established, the usage of the radio bearers and logical channels may be for transmitting and receiving an RRC signal. Further, also when the radio bearers and logical channels are re-established due to reconnection or a handover, similarly, the usage of the radio bearers and logical channels may be for transmitting and receiving an RRC signal.

In step S602, the CN signal reception unit 504 of the base station eNB receives a switching request signal from the EPC 1. The switching request signal may be a control signal transmitted from the MME (e.g., S1-AP message) or a control signal transmitted from the SGW. Further, the switching request signal may include a QoS parameter indicating QoS corresponding to the user data the EPC 1 is going to transmit to the user apparatus UE (e.g., QCI or EPS bearer ID), or information indicating that the MME is going to transmit a NAS signal to the user apparatus UE (hereinafter, referred to as “NAS transmission indication information).

Further, the CN signal reception unit 504 of the base station eNB may, by receiving a message including a NAS signal from the MME, determine that the usage of the radio bearers and logical channels is requested to be switched to for transmitting and receiving an RRC signal in which the NAS signal is encapsulated.

It should be noted that the processing steps of step S602 may be performed only in the case where there is data the EPC 1 is going to transmit to the user apparatus UE.

In step S603, the requesting unit 403 of the user apparatus UE transmits a switching request signal to the base station eNB. The switching request signal may be an RRC signal, a PDCP signal, an RLC signal, a MAC control element (CE), or a physical layer signal. The switching request signal may include a QoS parameter corresponding to the user data the user apparatus UE is going to transmit (e.g., QCI or EPS bearer ID), or information indicating that the user apparatus UE is going to transmit an RRC signal to the base station eNB.

It should be noted that the processing steps of step S603 may be performed in the case where there is data the user apparatus UE is going to transmit to the base station eNB and the data to be transmitted does not match the usage of the radio bearers and the logical channels.

In step S604, the usage control unit 505 of the base station eNB transmits a switching instruction signal to the user apparatus UE. The switching instruction signal includes information indicating the usage of the radio bearers and logical channels. The information may indicate transmitting and receiving a QoS parameter (e.g., QCI or EPS bearer ID) or an RRC signal. Further, the usage control unit 505 reports to the layer 2 control unit 506 that the usage of the radio bearers and logical channels is going to be switched. The switching instruction signal may be an RRC signal, a PDCP signal, an RLC signal, a MAC CE, or a physical layer signal.

In step S605, the accepting unit 404 of the user apparatus UE may transmit a switching instruction reception reporting signal in order to report to the base station eNB that the switching instruction signal has been received. The switching instruction reception reporting signal may be, for example, an RRC signal, a PDCP signal, an RLC signal, a MAC CE, or a physical layer signal.

In step S606, in the case where the switching request is received in processing steps of step S602, the CN signal reception unit 504 of the base station eNB may transmit a switching reporting signal to the EPC 1 in order to report that the switching instruction signal has been transmitted to the user apparatus UE.

In step S607, the layer 2 control unit 405 of the user apparatus UE and the layer 2 control unit 506 of the base station eNB switch the usage of radio bearers and logical channels to the usage specified in the processing steps of step S604.

It should be noted that, when switching the usage of radio bearers and logical channels, the layer 2 control unit 405 of the user apparatus UE and the layer 2 control unit 506 of the base station eNB may perform RLC re-establish processing or PDCP re-establish processing in order to remove data stored in the RLC layer and the PDCP layer. Further, similarly, the layer 2 control unit 405 of the user apparatus UE and the layer 2 control unit 506 of the base station eNB may remove data stored in the HARQ buffer in the MAC layer.

In step S608, transmission and reception of the user data or the RRC signal are performed according to the usage of radio bearers and logical channels.

(Switching Method (No. 2))

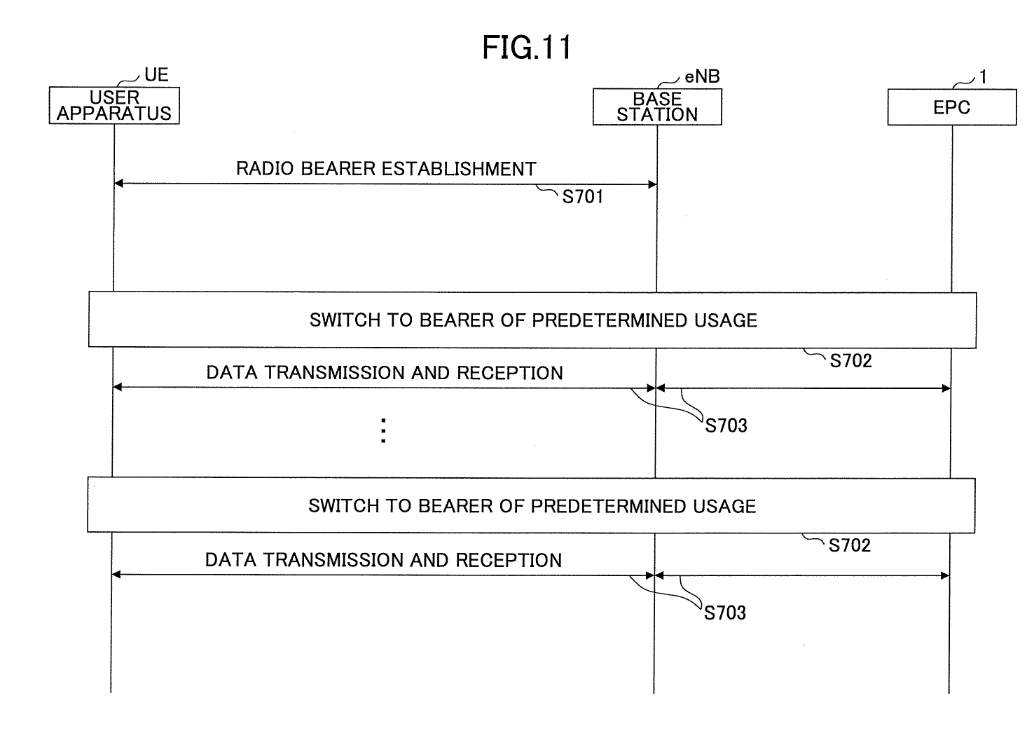

FIG. 11 is a sequence diagram illustrating an example of processing steps (No. 2) performed by a mobile communication system according to the second embodiment. Referring to FIG. 11, the processing steps (No. 2) will be specifically described in which the usage of radio bearers and logical channels established between the user apparatus UE and the base station eNB is switched.

Processing steps of step S701 are the same as those of step S601 of FIG. 10, and thus, the description will be omitted.

In step S702, the layer 2 control unit 405 of the user apparatus UE and the layer 2 control unit 506 of the base station eNB switch the usage of radio bearers and logical channels according to the periodic timing predefined between the user apparatus UE and the base station eNB. The CN signal transmission unit 503 and the CN signal reception unit 504 of the base station eNB may also switch the usage of the S1 bearer established between the base station eNB and the SGW at the similar timing.

It should be noted that, when switching the usage of radio bearers and logical channels, the layer 2 control unit 405 of the user apparatus UE and the layer 2 control unit 506 of the base station eNB may perform RLC re-establish processing or PDCP re-establish processing in order to remove data stored in the RLC layer and the PDCP layer. Further, similarly, the layer 2 control unit 405 of the user apparatus UE and the layer 2 control unit 506 of the base station eNB may remove data stored in the HARQ buffer in the MAC layer.

In step S703, transmission and reception of the user data or the RRC signal are performed according to the usage of radio bearers and logical channels.

Afterwards, the usage of radio bearers and logical channels is periodically switched by having processing steps of step S702 and step S703 periodically repeated. The period at which the usage of radio bearers and logical channels is switched may be, for example, equal to or longer than a radio frame period (10 ms). Further, the periods allocated to usages of the corresponding radio bearers and logical channels may not be uniform. For example, the period for performing transmission and reception of the RRC signal may be longer.

(Switching Method (No. 3))

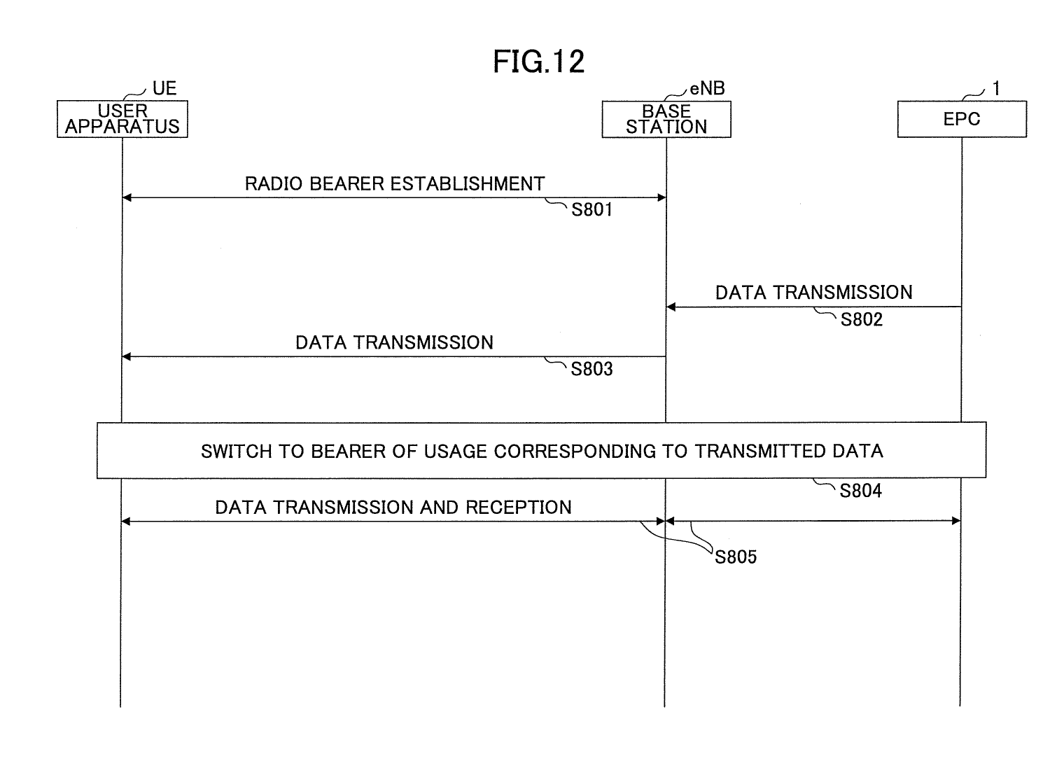

FIG. 12 is a sequence diagram illustrating an example of processing steps (No. 3) performed by a mobile communication system according to the second embodiment. Referring to FIG. 12, the processing steps (No. 3) will be specifically described in which the usage of radio bearers and logical channels established between the user apparatus UE and the base station eNB is switched.

The processing steps of step S801 are the same as those of step S601 of FIG. 10 and those of step S701 of FIG. 11, and thus, the description is omitted.

In step S802, the CN signal reception unit 504 of the base station eNB receives data from the EPC 1. The data received from the EPC 1 includes a QoS parameter (e.g., QCI or EPS bearer ID) or information indicating that the data is a NAS message.

In step S803, the radio signal transmission unit 501 of the base station eNB transmits to the user apparatus UE an RRC signal which encapsulates the data received in step S802 or the NAS message received in step S802. In the case where the data transmitted to the user apparatus is user data, in order to indicate the usage of radio bearers and logical channels, a QoS parameter (e.g., QCI or ESP bearer ID) corresponding to the user data is included.

In step S804, during a certain period of time from when user data or an RRC signal is transmitted in processing steps of step S803, the layer 2 control unit 405 of the user apparatus UE and the layer 2 control unit 506 of the base station eNB switch the usage of radio bearers and logical channels to a state where transmitting and receiving user data corresponding to the QoS or the RRC signal can be performed.

It should be noted that, when switching the usage of radio bearers and logical channels, the layer 2 control unit 405 of the user apparatus UE and the layer 2 control unit 506 of the base station eNB may perform RLC re-establish processing or PDCP re-establish processing in order to remove data stored in the RLC layer or the PDCP layer. Further, similarly, the layer 2 control unit 405 of the user apparatus UE and the layer 2 control unit 506 of the base station eNB may remove data stored in the HARQ buffer in the MAC layer.

In step S805, transmission and reception of the user data or the RRC signal are performed according to the usage of radio bearers and logical channels.

As described above, the methods (No. 1 to No. 3) of switching the usage of radio bearers and logical channels have been described. The switching method (No. 1) may be applied to the switching method (No. 2) and the switching method (No. 3). Specifically, in processing steps described by referring to FIG. 11 and FIG. 12, the base station eNB may forcibly change the usage of radio bearers and logical channels by performing processing steps of step S604 if necessary.

### Third Embodiment

Next, a third embodiment will be described by referring to the drawings. It should be noted that the description of the same parts as the first embodiment will be omitted. Further, what is not specifically described may be the same as the first embodiment.

In a mobile communication system according to the third embodiment, a single radio bearer and a single logical channel between a user apparatus UE and a base station eNB is established, and then user data sets corresponding to multiple QoSs and an RRC signal are multiplexed to the established radio bearer and logical channel.

As described above, in conventional LTE, it is necessary to have processing capability of communications of simultaneously using at least two SRBs and four RLC-AM DRBs. According to the third embodiment, all data sets are multiplexed to a single radio bearer and a single logical channel. In other words, the user apparatus UE only needs to establish a single radio bearer and a single logical channel, and thus, it is possible to reduce use of processing capability of the user apparatus UE.

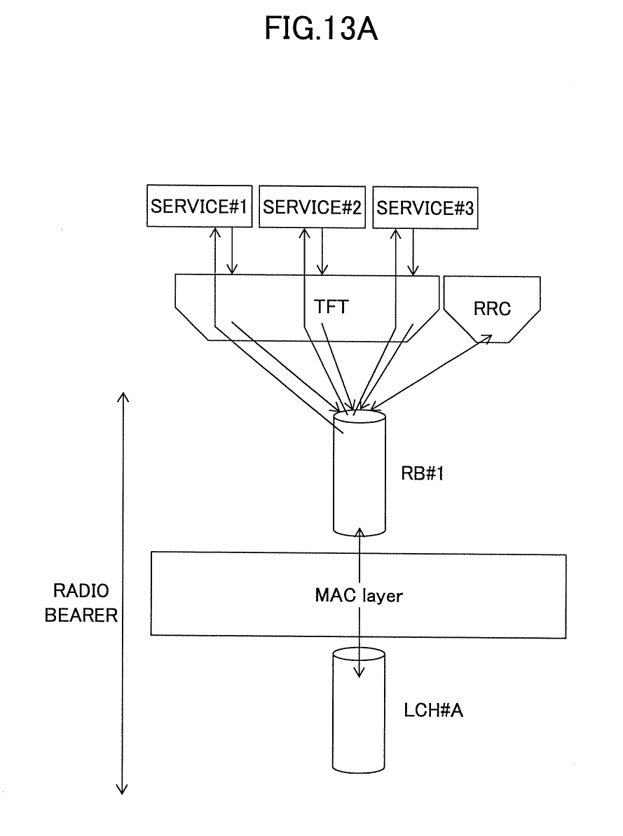

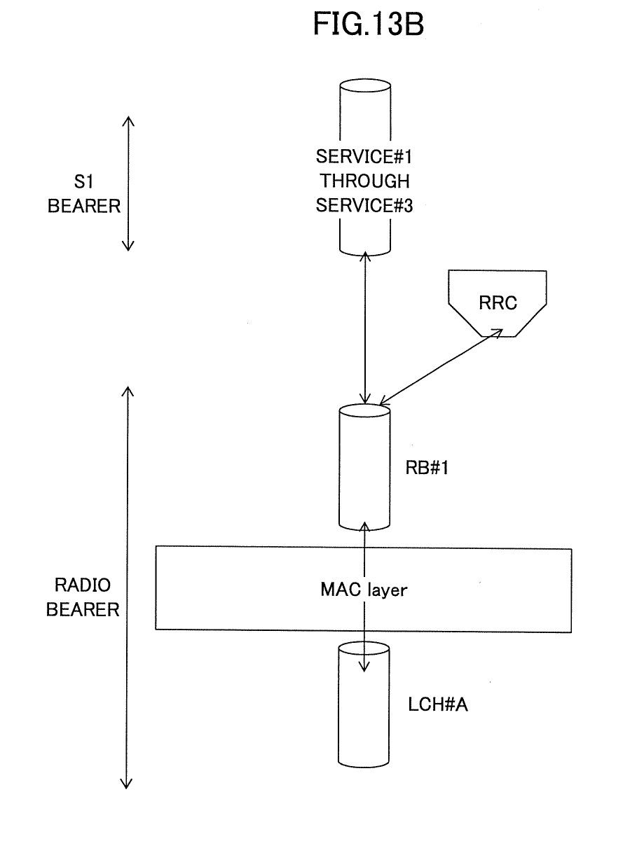

FIG. 13A and FIG. 13B are drawings illustrating examples of a structure of radio bearers and logical channels according to the third embodiment. FIG. 13A illustrates an example of a structure of a radio bearer and a logical channel established by a user apparatus UE, and FIG. 13B illustrates an example of a structure of a radio bearer and a logical channel established by a base station eNB. Further, points not specifically described may be the same as FIG. 2A, FIG. 2B, FIG. 7A, or FIG. 7B.

FIG. 13A illustrates a state in which user data sets related to service#1 through service#3 and an RRC signal are multiplexed and transmitted and received by using the RB#1 and the LCH#A. FIG. 13A illustrates a state in which user data sets related to service#1 through service#3 and an RRC signal are multiplexed, transmitted, and received by using the RB#1 and the LCH#A.

It should be noted that, in an example of FIG. 13B, it is assumed, but not limited to, that a single S1 bearer is established between the base station eNB and the SGW.

In the third embodiment, the user data sets corresponding to multiple QoSs and the RRC signal are multiplexed by using a single radio bearer and a single logical channel. Therefore, for example, the multiplexed data sets can be separated (demultiplexed) by the base station eNB or the user apparatus UE by adding information indicating contents of the data included in the PDUs (e.g., information indicating a QoS parameter and an RRC signal) in the header, etc., of PDUs used by the radio bearer and the logical channel.

It should be noted that, in the third embodiment, a radio bearer and a logical channel used for transmitting and receiving user data, and a radio bearer and a logical channel used for transmitting and receiving an RRC signal may be established separately.

<Functional Structure>

(User Apparatus)

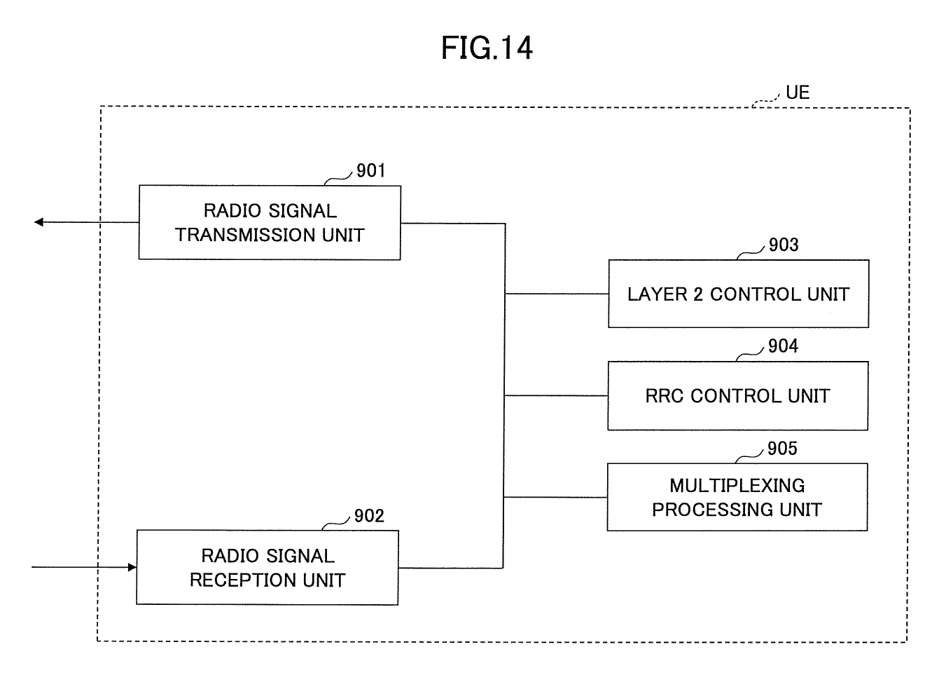

FIG. 14 is a drawing illustrating an example of a functional structure of a user apparatus UE according to the third embodiment. As illustrated in FIG. 14, the user apparatus UE includes a radio signal transmission unit 901, a radio signal reception unit 902, a layer 2 control unit 903, an RRC control unit 904, and a multiplexing processing unit 905. FIG. 14 illustrates functional units of the user apparatus UE especially related to an embodiment only, and thus, the user apparatus UE further includes at least functions for performing operations according to LTE (not shown in the figure). Further, a functional structure illustrated in FIG. 14 is merely an example. Functional classification and names of functional units may be anything as long as operations related to an embodiment can be performed.

The radio signal transmission unit 901 and the radio signal reception unit 902 include a packet buffer and perform processing of physical layer (layer 1), respectively.

The layer 2 control unit 903 performs processing of layer 2 (media access control (MAC) layer, RLC layer, packet data convergence protocol (PDCP) layer) with the base station eNB.

The RRC control unit 904 performs RRC signal transmission and reception to and from the base station eNB, and performs various types of RRC layer related processes.

The multiplexing processing unit 905 has a function for multiplexing data sets transmitted in the services and an RRC signal into a single radio bearer and a single logical channel by including the data sets transmitted in the services performed by the user apparatus UE and the RRC signals in the data portion of a PDU used by the radio bearer and the logical channel, and adding in the header portion of the PDU a QoS parameter indicating corresponding QoSs required for the services and information indicating the RRC signal.

Further, the multiplexing processing unit 905 has a function for separating the user data sets and the RRC signals included in the PDU based on the information indicating the QoS parameter and the RRC signal added in the header portion of the PDU received from the base station eNB. It should be noted that the multiplexing processing unit 905 may include the TFT function illustrated in FIG. 13.

(Base Station)

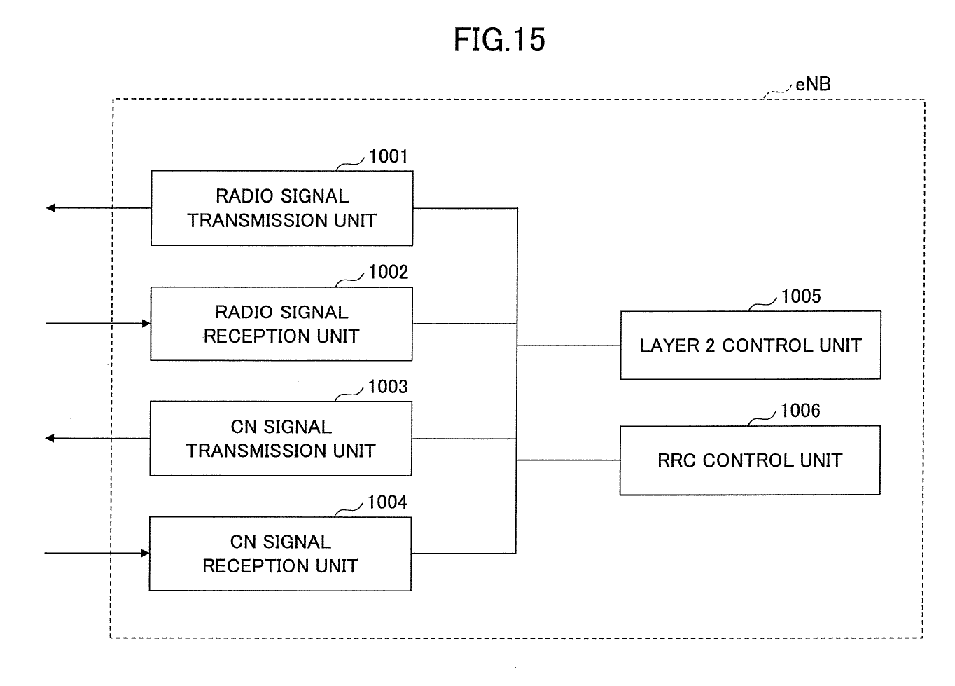

FIG. 15 is a drawing illustrating an example of a functional structure of a base station eNB according to the third embodiment. As illustrated in FIG. 15, the base station eNB includes a radio signal transmission unit 1001, a radio signal reception unit 1002, a CN signal transmission unit 1003, a CN signal reception unit 1004, a layer 2 control unit 1005, and an RRC control unit 1006. FIG. 15 illustrates functional units of the base station eNB especially related to an embodiment only, and thus, the base station eNB further includes at least functions for performing operations according to LTE (not shown in the figure). Further, a functional structure illustrated in FIG. 15 is merely an example. Functional classification and names of functional units may be anything as long as operations related to an embodiment can be performed.

The radio signal transmission unit 1001, the radio signal reception unit 1002, the CN signal transmission unit 1003, and the CN signal reception unit 1004 are the same as the radio signal transmission unit 201, the radio signal reception unit 202, the CN signal transmission unit 203, and the CN signal reception unit 204 according to the first embodiment, and thus, the descriptions are omitted.

The layer 2 control unit 1005 performs processing of layer 2 (media access control (MAC) layer, RLC layer, packet data convergence protocol (PDCP) layer) with the user apparatus UE. Further, the layer 2 control unit 1005 transmits to the user apparatus UE the PDU in which the user data from the EPC 1 received by the CN signal reception unit 1004 and the RRC signal from the RRC control unit 1006 are multiplexed. Further, the layer 2 control unit 1005 separates the RRC signal and the user data from the PDU received from the user apparatus UE.

The RRC control unit 1006 performs RRC signal transmission and reception to and from the user apparatus UE, and performs various types of RRC layer related processes.

<Processing Steps>

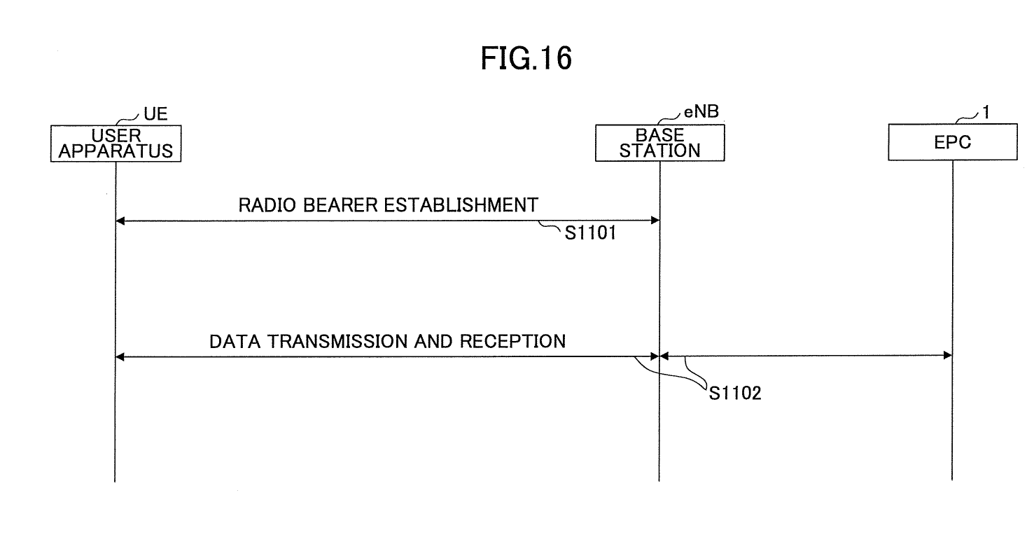

FIG. 16 is a sequence diagram illustrating an example of processing steps performed by a mobile communication system according to the third embodiment.

In step S1101, a single radio bearer and a logical channel are established between the layer 2 control unit 903 of the user apparatus UE and the layer 2 control unit 1005 of the base station eNB.

In step S1102, the multiplexing processing unit 905 and the radio signal transmission unit 901 of the user apparatus UE include the data transmitted in the services performed by the user apparatus UE and the RRC signal in the data portion of the PDU used by the radio bearer and the logical channel, add in the header portion of the PDU a QoS parameter indicating the QoS required by the services and information indicating the RRC signal, and transmit the added result to the base station eNB. Further, the layer 2 control unit 1005 of the base station eNB separates the RRC signal and the user data from the received PDU. The CN signal transmission unit 1003 of the base station eNB transmits the separated user data to the EPC 1 via the S1 bearer.

Further, the layer 2 control unit 1005 of the base station eNB transmits to the user apparatus UE the PDU in which the RRC signal and the user data from the EPC 1 received by the CN signal reception unit 1004 are multiplexed. Further, the multiplexing processing unit 905 of the user apparatus UE separates the user data and the RRC signal included in the PDU based on the QoS parameter and the information indicating the RRC signal added in the header portion of the PDU received from the base station eNB.

<Hardware Structure>

As described above, functional structures of a user apparatus UE and a base station eNB according to the first through third embodiments may be entirely realized by a hardware circuit (e.g., one or more IC chips), or partially realized by a hardware circuit and other parts may be realized by a CPU and a program.

(User Apparatus)

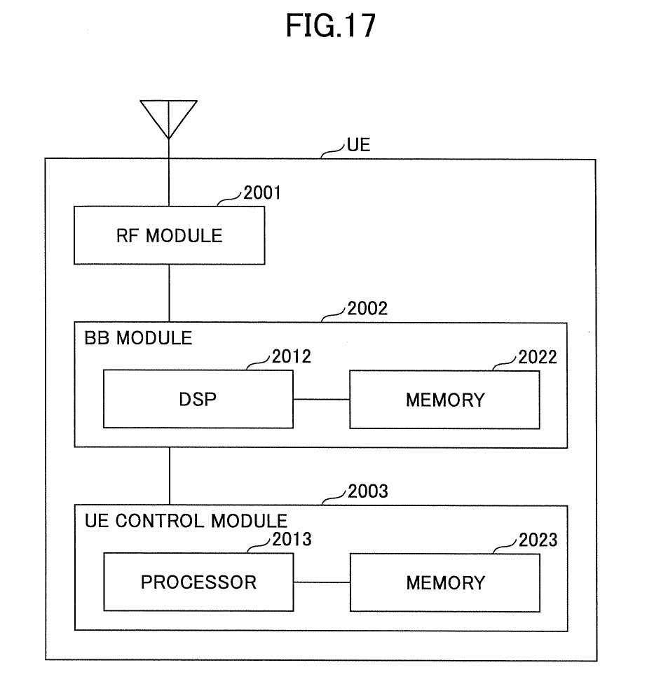

FIG. 17 is a drawing illustrating an example of a hardware configuration of a user apparatus UE according to an embodiment. FIG. 17 illustrates a structure closer to an implementation example compared to FIG. 4, FIG. 8, and FIG. 14. As illustrated in FIG. 17, the user apparatus UE includes a radio frequency (RF) module 2001 for performing a process related to a wireless signal, a baseband (BB) processing module 2002 for performing a baseband signal process, and a UE control module 2003 for performing a process of an upper layer, etc. The RF module 2001 generates a radio signal to be transmitted from an antenna by performing digital-to-analog (D/A) conversion, modulation, frequency conversion, power amplification, etc., for a digital baseband signal received from the BB processing module 2002. Further, the RF module 2001 generates a digital baseband signal by performing frequency conversion, analog to digital (A/D) conversion, demodulation, etc., for a received radio signal, and transmits the generated signal to the BB processing module 2002. The RF module 2001 includes, for example, a part of the radio signal transmission unit 101 and a part of the radio signal reception unit 102 illustrated in FIG. 4; a part of the radio signal transmission unit 401 and a part of the radio signal reception unit 402 illustrated in FIG. 8; and a part of the radio signal transmission unit 901 and a part of the radio signal reception unit 902 illustrated in FIG. 14.

The BB processing module 2002 performs a process of converting bidirectionally between an IP packet and a digital baseband signal. A Digital signal processor (DSP) 2012 is a processor for performing signal processing in the BB processing module 2002. A memory 2022 is used as a work area of the DSP 2012. The BB processing module 2002 includes, for example, a part of the radio signal transmission unit 101, a part of the radio signal reception unit 102, and the layer 2 control unit 106 illustrated in FIG. 4; a part of the radio signal transmission unit 401, a part of the radio signal reception unit 402, and the layer 2 control unit 405 illustrated in FIG. 8; and a part of the radio signal transmission unit 901, a part of the radio signal reception unit 902, and the layer 2 control unit 903 illustrated in FIG. 14.

The UE control module 2003 performs an IP layer protocol process, processes of various types of applications, etc. A processor 2013 performs a process for the UE control module 2003. A memory 2023 is used as a work area of the processor 313. The UE control module 2003 includes, for example, the capability reporting unit 103, the requesting unit 104, the accepting unit 105, the RRC control unit 107, and the mapping processing unit 108 illustrated in FIG. 4; the requesting unit 403, the accepting unit 404, the RRC control unit 406, and the mapping processing unit 407 illustrated in FIG. 8; and the RRC control unit 904 and the multiplexing processing unit 905 illustrated in FIG. 14.

(Base Station)

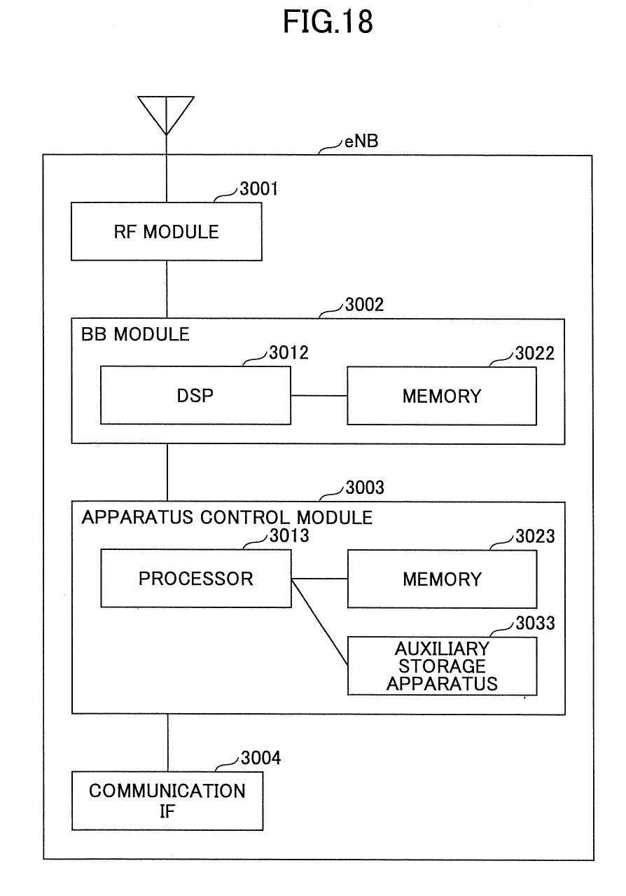

FIG. 18 is a drawing illustrating an example of a hardware configuration of a base station 2 according to an embodiment. FIG. 18 illustrates a structure closer to an implementation example compared to FIG. 5, FIG. 9, or FIG. 15. As illustrated in FIG. 18, the base station eNB includes an RF module 3001 for performing a process related to a radio signal, a BB processing module 3002 for performing a baseband signal process, an apparatus control module 3003 for performing a process of an upper layer, etc., and a communication IF 3004 as an interface for connecting to a network.

The RF module 3001 generates a radio signal to be transmitted from an antenna by performing D/A conversion, modulation, frequency conversion, power amplification, etc., for a digital baseband signal received from the BB processing module 3002. Further, the RF module 3001 generates a digital baseband signal by performing frequency conversion, A/D conversion, demodulation, etc., for a received radio signal, and transmits the generated signal to the BB processing module 3002. The RF module 3001 includes, for example, a part of the radio signal transmission unit 201 and a part of the radio signal reception unit 202 illustrated in FIG. 5; a part of the radio signal transmission unit 501 and a part of the radio signal reception unit 502 illustrated in FIG. 9; and a part of the radio signal transmission unit 1001 and a part of the radio signal reception unit 1002 illustrated in FIG. 15.

The BB processing module 3002 performs a process of converting bidirectionally between an IP packet and a digital baseband signal. DSP 3012 is a processor for performing a signal processing in the BB processing module 3002. A memory 3022 is used as a work area of the DSP 3012. The BB processing module 3002 includes, for example, a part of the radio signal transmission unit 201, a part of the radio signal reception unit 202, and the layer 2 control unit 207 illustrated in FIG. 5; a part of the radio signal transmission unit 501, a part of the radio signal reception unit 502, and the layer 2 control unit 506 illustrated in FIG. 9; and a part of the radio signal transmission unit 1001, a part of the radio signal reception unit 1002, and the layer 2 control unit 1005 illustrated in FIG. 15.

The apparatus control module 3003 performs an IP layer protocol process, an operation and maintenance (DAM) process, etc. A processor 3013 performs a process for the apparatus control module 3003. A memory 3023 is used as a work area of the processor 3013. An auxiliary storage apparatus 3033 is, for example, an HDD, etc., and stores various types of setting information items, etc., used for operations of the base station eNB. The apparatus control module 3003 includes, for example, the capability information storing unit 205, the activation control unit 206, and the RRC control unit 208 illustrated in FIG. 5; the usage control unit 505, the RRC control unit 507 illustrated in FIG. 9; and the RRC control unit 1006 illustrated in FIG. 15.

The communication IF 3004 includes, for example, the CN signal transmission unit 203 and the CN signal reception unit 204 illustrated in FIG. 5; the CN signal transmission unit 503 and the CN signal reception unit 504 illustrated in FIG. 9; and the CN signal transmission unit 1003 and the CN signal reception unit 1004 illustrated in FIG. 15.

### SUMMARY

As described above, according to an embodiment, a user apparatus is provided which communicates with a base station in a mobile communication system which supports LTE. The user apparatus includes a bearer establishing unit configured to establish one or more radio bearers between the user apparatus and the base station; a control unit configured to control activation or deactivation of each of the established radio bearers based on an instruction from the base station; and a communication unit configured to transmit and receive data to and from the base station by using the activated radio bearers. According to the above-described user apparatus UE, it is possible to reduce radio bearers used for radio communications performed between the user apparatus and the base station.

Further, the user apparatus UE may include a reporting unit configured to transmit to the base station capability information indicating the number of radio bearers the user apparatus can activate at the same time. With the above arrangement, it is possible for the user apparatus UE to cause the base station eNB to let the user apparatus UE activate radio bearers and logical channels within a range not exceeding the processing capability of the user apparatus UE.

Further, the control unit may activate the one or more radio bearers established by the bearer establishing unit in the case where the number of one or more radio bearers established by the bearer establishing unit is equal to or less than the number of radio bearers the user apparatus can activate at the same time. With the above arrangement, in the case where the radio bearers are established within a range of the processing capability of the user apparatus UE, it is possible for the user apparatus UE to prevent the base station eNB from transmitting a control signal for activating the radio bearers, and thus, it is possible to reduce control signals transmitted and received between the base station eNB and the user apparatus UE.

Further, the one or more radio bearers may include one or more user data transmission and reception bearers corresponding to one or more QoS parameters, and the communication unit may transmit the user data corresponding to a predetermined QoS parameter of the one or more QoS parameters to the base station by using the user data transmission and reception bearer which is activated and corresponding to the predetermined QoS parameter. With the above arrangement, when transmitting to the base station eNB the user data corresponding to a predetermined QoS, the user apparatus UE transmits the user data only in the case where the radio bearer corresponding to the predetermined QoS is activated. Therefore, it is possible to reduce the number of radio bearers and logical channels used simultaneously for communications.

Further, according to an embodiment, a user apparatus is provided which communicates with a base station in a mobile communication system which supports LTE. The user apparatus includes a bearer establishing unit configured to establish a radio bearer between the user apparatus and the base station, multiple usages of which bearer can be switched; a control unit configured to switch the established radio bearer to any one of the multiple usages; and a communication unit configured to, in the case where the radio bearer is switched to a predetermined usage, transmit and receive data corresponding to the predetermined usage to and from the base station. According to the above-described user apparatus UE, it is possible to reduce radio bearers used for radio communications performed between the user apparatus and the base station. Further, the control unit may switch the established radio bearer to any one of the multiple usages based on an instruction from the base station, based on a predefined switching pattern, or based on data received from the base station. With the above arrangement, it is possible for the user apparatus UE to switch the usage of the radio bearer by using various methods according to contents, etc., of data transmitted and received to and from the base station eNB.

Further, it is possible to switch the radio bearer to any one of a radio bearer used for transmitting and receiving a control signal, and one or more user data transmission and reception bearers corresponding to one or more QoS parameters. When establishing the radio bearer between the user apparatus and the base station, the bearer establishing unit may establish a radio bearer used for transmitting and receiving a control signal. With the above arrangement, it is possible for the user apparatus UE to transmit and receive a control signal immediately when the bearer is established between the user apparatus UE and the base station eNB.

Further, according to an embodiment, a user apparatus is provided which communicates with a base station in a mobile communication system which supports LTE. The user apparatus includes a bearer establishing unit configured to establish a single radio bearer between the user apparatus and the base station; and a transmission unit configured to transmit a control signal and one or more user data sets corresponding to one or more QoS parameters by using the established single radio bearer. According to the above-described user apparatus UE, it is possible to reduce radio bearers used for radio communications performed between the user apparatus and the base station.

Further, according to an embodiment, a base station is provided which communicates with a user apparatus in a mobile communication system which supports LTE. The base station includes a bearer establishing unit configured to establish one or more radio bearers between the base station and the user apparatus; a control unit configured to instruct the user apparatus to activate or deactivate the one or more radio bearers established between the base station and the user apparatus; and a communication unit configured to transmit and receive data to and from the user apparatus by using the activated bearers of the one or more radio bearers. According to the above-described base station eNB, it is possible to reduce radio bearers used for radio communications performed between the user apparatus and the base station.

Further, according to an embodiment, a base station is provided which communicates with a user apparatus in a mobile communication system which supports LTE. The base station includes a bearer establishing unit configured to establish a radio bearer between the base station and the user apparatus, multiple usages of which bearer can be switched; a control unit configured to switch the established radio bearer to any one of the multiple usages; and a communication unit configured to, in the case where the radio bearer is switched to a predetermined usage, transmit and receive data corresponding to the predetermined usage to and from the user apparatus. According to the above-described base station eNB, it is possible to reduce radio bearers used for radio communications performed between the user apparatus and the base station.

Further, the “unit” included in the above apparatuses may be substituted by “means”, “circuit”, “device”, etc.

<Supplementary Description of Embodiment>

The apparatuses (user apparatus UE/base station eNB) according to an embodiment may include a CPU and a memory, may be realized by having a program executed by the CPU (processor), may be realized by hardware such as hardware circuitry in which the logic described in an embodiment is included, or may be realized by a mixture of a program and hardware.

As described above, embodiments have been described. The disclosed invention is not limited to these embodiments, and a person skilled in the art would understand various variations, modifications, replacements, or the like. Specific examples of numerical values have been used for encouraging understanding of the present invention. These numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. The order of steps in the above described sequences and flowcharts according to an embodiment may be changed as long as there is no contradiction. For the sake of description convenience, the user apparatus UE and the base station eNB have been described by using functional block diagrams. These apparatuses may be implemented by hardware, by software, or by combination of both. The software which is executed by a processor included in a user apparatus UE according to an embodiment and the software which is executed by a processor included in a base station eNB may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

The present invention is not limited to the above embodiments and various variations, modifications, alternatives, replacements, etc., may be included in the present invention without departing from the spirit of the invention.

It should be noted that, in an embodiment, the layer 2 control unit 106, the layer 2 control unit 405, or the layer 2 control unit 903 is an example of the bearer establishing unit and a control unit. The radio signal transmission unit 101, the radio signal transmission unit 401, the radio signal transmission unit 901, the radio signal reception unit 102, the radio signal reception unit 402, or the radio signal reception unit 902 is an example of the communication unit. The capability reporting unit 103 is an example of the reporting unit. The layer 2 control unit 207, the layer 2 control unit 506, or the layer 2 control unit 1005 is an example of the bearer establishing unit. The activation control unit 206 or the usage control unit 505 is an example of the control unit. The radio signal transmission unit 201, the radio signal transmission unit 501, the radio signal transmission unit 1001, the radio signal reception unit 202, the radio signal reception unit 502, or the radio signal reception unit 1002 is an example of the communication unit.

The present application is based on and claims the benefit of priority of Japanese Priority Application No. 2015-100561 filed on May 15, 2015, the entire contents of which are hereby incorporated by reference.

### DESCRIPTION OF THE REFERENCE NUMERALS

UE user apparatus
eNB base station
1 EPC
101 Radio signal transmission unit
102 Radio signal reception unit
103 Capability reporting unit
104 Requesting unit
105 Accepting unit
106 Layer 2 control unit
107 RRC control unit
108 Mapping processing unit
201 Radio signal transmission unit
202 Radio signal reception unit
203 CN signal transmission unit
204 CN signal reception unit
205 Capability information storing unit
206 Activation control unit
207 Layer 2 control unit
208 RRC control unit
401 Radio signal transmission unit
402 Radio signal reception unit
403 Requesting unit
404 Accepting unit
405 Layer 2 control unit
406 RRC control unit
407 Mapping processing unit
501 Radio signal transmission unit
502 Radio signal reception unit
503 CN signal transmission unit
504 CN signal reception unit
505 Usage control unit
506 Layer 2 control unit
507 RRC control unit
901 Radio signal transmission unit
902 Radio signal reception unit
903 Layer 2 control unit
904 RRC control unit
905 Multiplexing processing unit
1001 Radio signal transmission unit
1002 Radio signal reception unit
1003 CN signal transmission unit
1004 CN signal reception unit
1005 Layer 2 control unit
1006 RRC control unit
2001 RF module
2002 BB processing module
2003 UE control module
3001 RF module
3002 BB processing module
3003 Apparatus control module
3004 Communication IF

1. A user apparatus communicating with a base station in a mobile communication system which supports Long Term Evolution (LTE), the user apparatus comprising:
a bearer establishing unit configured to establish one or more radio bearers between the user apparatus and the base station;
a control unit configured to control activation and deactivation of each of the established one or more radio bearers based on an instruction from the base station; and
a communication unit configured to transmit and receive data to and from the base station by using the activated radio bearers of the one or more radio bearers.

2. The user apparatus according to claim 1, further comprising:
a reporting unit configured to transmit to the base station capability information indicating the number of radio bearers the user apparatus can activate at the same time.

3. The user apparatus according to claim 2, wherein the control unit activates the one or more radio bearers established by the bearer establishing unit in the case where the number of one or more radio bearers established by the bearer establishing unit is equal to or less than the number of radio bearers the user apparatus can activate at the same time.

4. The user apparatus according to claim 1, wherein
the one or more radio bearers include one or more user data transmission and reception bearers corresponding to one or more QoS parameters, and wherein the communication unit transmits to the base station the user data corresponding to a predetermined QoS parameter of the one or more QoS parameters by using the user data transmission and reception bearer which is activated and corresponding to the predetermined QoS parameter.

5. A user apparatus communicating with a base station in a mobile communication system which supports Long Term Evolution (LTE), the user apparatus comprising:
a bearer establishing unit configured to establish a radio bearer between the user apparatus and the base station, multiple usages of which radio bearer can be switched;
a control unit configured to switch the established radio bearer to any one of the multiple usages; and
a communication unit configured to, in the case where the radio bearer is switched to a predetermined usage, transmit and receive data corresponding to the predetermined usage to and from the base station.

6. The user apparatus according to claim 5, wherein the control unit switches the established radio bearer to any one of the multiple usages based on an instruction from the base station, based on a predefined switching pattern, or based on data received from the base station.

7. The user apparatus according to claim 5, wherein
the radio bearer can be switched to any one of a bearer used for transmitting and receiving a control signal and one or more user data transmission and reception bearers corresponding to one or more QoS parameters, and wherein
the bearer establishing unit establishes a radio bearer used for transmitting and receiving a control signal when the bearer establishing unit establishes the radio bearer between the user apparatus and the base station.

8. A user apparatus communicating with a base station in a mobile communication system which supports Long Term Evolution (LTE), the user apparatus comprising:
a bearer establishing unit configured to establish a single radio bearer between the user apparatus and the base station; and
a transmission unit configured to transmit a control signal and one or more user data sets corresponding to one or more QoS parameters by using the established single radio bearer.

9. A base station communicating with a user apparatus in a mobile communication system which supports Long Term Evolution (LTE, the base station comprising:
a bearer establishing unit configured to establish one or more radio bearers between the base station and the user apparatus;
a control unit configured to instruct the user apparatus to activate and deactivate each of the one or more radio bearers established between the base station and the user apparatus; and
a communication unit configured to transmit and receive data to and from the user apparatus by using the activated bearer of the one or more radio bearers.

10. A base station communicating with a user apparatus in a mobile communication system which supports Long Term Evolution (LTE), the base station comprising:
a bearer establishing unit configured to establish a radio bearer between the base station and the user apparatus, multiple usages of which radio bearer can be switched;
a control unit configured to switch the established radio bearer to any one of the multiple usages; and
a communication unit configured to, in the case where the radio bearer is switched to a predetermined usage, transmit and receive data corresponding to the predetermined usage to and from the user apparatus.

11. The user apparatus according to claim 2, wherein
the one or more radio bearers include one or more user data transmission and reception bearers corresponding to one or more QoS parameters, and wherein the communication unit transmits to the base station the user data corresponding to a predetermined QoS parameter of the one or more QoS parameters by using the user data transmission and reception bearer which is activated and corresponding to the predetermined QoS parameter.

12. The user apparatus according to claim 3, wherein
the one or more radio bearers include one or more user data transmission and reception bearers corresponding to one or more QoS parameters, and wherein the communication unit transmits to the base station the user data corresponding to a predetermined QoS parameter of the one or more QoS parameters by using the user data transmission and reception bearer which is activated and corresponding to the predetermined QoS parameter.

13. The user apparatus according to claim 6, wherein
the radio bearer can be switched to any one of a bearer used for transmitting and receiving a control signal and one or more user data transmission and reception bearers corresponding to one or more QoS parameters, and wherein
the bearer establishing unit establishes a radio bearer used for transmitting and receiving a control signal when the bearer establishing unit establishes the radio bearer between the user apparatus and the base station.
